(19) United States
(12) Patent Application Publication
(10) Pub. No.: US 2009/0122941 A1
(43) Pub. Date: May 14, 2009

(54) Device for Producing an Atmospheric Pressure Plasma

(76) Inventors: Jurgen Engemann, Wuppertal (DE); Markus Teschke, Dusseldorf (DE)

Correspondence Address: K.F. ROSS P.C., 5683 RIVERDALE AVENUE, SUITE 203 BOX 900, BRONX, NY, 10471-0900, US

(21) Appl. No.: 11/988,810

(22) PCT Filed: Jul. 14, 2006
(86) PCT No.: PCT/DE2006/001234

§ 371 Date: Jan. 14, 2008

(30) Foreign Application Priority Data
Jul. 14, 2005 (DE) 10 2005 032 890.3

(51) Int. Cl. H05H 1/24

(52) U.S. Cl. 376/145

(57) ABSTRACT

The invention relates inter alia to a device (10) for producing an atmospheric pressure plasma (20, 20a, 20b, 20c, 20d), especially for treating a substrate, said device comprising a unit (11, 11a, 11b, 11c) produced from a piezoelectric material. Said unit has at least one primary region (12, 12a, 12b, 12c) in which at least two electrodes (17a, 17b, 17c) for applying a low AC voltage are arranged, and a secondary region (13), along the longitudinal direction (L) of which potential differences are produced when the primary region is incited. The invention is inter alia characterized in that the secondary region (13) comprises two partial regions (14, 14a, 14b, 14c, 15, 15a, 15b, 15c) that have an opposite polarity along the longitudinal direction (L).

The invention relates to an apparatus for generating an atmospheric-pressure plasma as indicated in the preamble of claim 1.

An atmospheric-pressure plasma as defined by the invention is a plasma that can be generated under atmospheric pressure, but optionally as well at higher pressures. In terms of apparatuses for generating an atmospheric-pressure plasma, vacuum apparatuses such as pumps, etc. can be eliminated. In contrast to apparatuses for generating low-pressure or low-temperatures plasmas, apparatuses of this type are thus basically of simple design.

The invention relates in particular to apparatuses for generating an atmospheric-pressure plasma that can function to treat a substrate. A substrate here is understood to refer, inter alia, to a two-dimensional or three-dimensional solid body whose surface can be treated, optionally also down to a specific treatment depth—for example, can be coated, activated, cleaned, modified, or treated in some other way. A substrate as defined by this patent application, however, can for example also be understood to be a gas flow to be treated—for example a gas flow to be cleaned.

Atmospheric-pressure plasmas can thus be divided into so-called “cold” nonthermal plasmas with a gas temperature of typically less than 100° C. and thermal plasmas with higher gas temperatures. This invention deals primarily with nonthermal plasmas that have the advantage that the gas temperature lies within the range of room temperature, or only slightly higher than this, with the result that even very sensitive substrates, such as, for example, thin polymer films, can be treated for a longer time period with this plasma without the surface of the substrate or the substrate itself being damaged.

Both in the case of barrier discharges, such as those disclosed, for example, in U.S. Pat. No. 5,637,279, and also in the case of apparatuses for generating an atmospheric-pressure glow discharge plasma, such as, for example, known to the applicant from DE 102 03 543, the supply of the high voltage required for ionizing the working gas is effected by an external high-voltage power supply apparatus separate from the excitation electrode, which apparatus contains a ferromagnetic electric transformer that generates a high voltage in the range of between 1 and 15 kV from a relatively low AC voltage—in the simplest case from a line voltage of 230V/50 Hz. Possible working gases include, e.g. inert gases, oxygen, nitrogen, or air. The high voltage generated in the high-voltage power supply apparatus is fed to the electrodes through electrically insulated cables. What is basically disadvantageous about this known apparatus for generating atmospheric-pressure plasmas having this type of ferromagnetic electrical transformer is its weight, its size, and the fact that the electric pulses created during formation of the ion-generating filaments (partial discharges) can be transmitted back through the transformer into the power supply. Although this can be suppressed by an isolating transformer, it nevertheless necessitates additional expense. In addition, to ensure electrical safety and protection against electromagnetic effects, the cables to the electrodes must be insulated, which step again increases the equipment cost. Added to this are high conversion and transmission losses.

An approach is known from DE 101 29 041 by which the required high voltage is generated by a controlled piezoelectric transformer (PT). This results in a significantly more compact design. This solution is based on the known piezoelectric effect in which rod-shaped piezoelectric ceramics put out a voltage in response to mechanical deformation; this technology is utilized, e.g. in ignition apparatuses. The principle of the piezoelectric transformer consists in the fact that the piezoelectric ceramic operated so as to resonate is made to vibrate in its primary region by applying a low AC voltage operating at the resonance point, while at its other end, the so-called secondary region, the generated mechanical vibrations are converted back into high AC electrical voltage. In the solution described in DE 101 29 041, the piezoelectric transformer is a separate component, i.e. the generated high voltage is passed through the above-described insulated supply cables to the electrodes.

An approach is already known from the publication (K. Teranishi, S. Suzuki, H. Itoh: “High Efficiency Ozone Production by a Compact Ozonizer Using Piezoelectric Transformer,” Chiba Institute of Technology), hereafter referenced as the Itoh publication, whereby in order to generate ozone by utilizing a plasma a piezoelectric transformer is employed to generate the high voltage, which transformer simultaneously assumes the function of the high voltage electrode. To this end, a flat traditional so-called Rosen-type PT is employed. What is designated as a Rosen-type PT is an apparatus compose of a piezoelectric material having essentially the shape of a flat elongated parallepiped. The parallepiped is divided into a primary region and a secondary region. Two electrodes are provided on the primary region that are separated by a distance that is determined by the thickness of the material. Applying a low AC voltage, that is, an AC voltage of an amplitude specifically of less than 500 V, makes the primary region vibrate. These vibrations are transmitted from the primary region to the secondary region. Since the secondary region has a predetermined polarization direction spanning the longitudinal extent of the secondary region, an electrical field or potential differences are created along the longitudinal extent of the secondary region.

The Rosen-type PT is preferably polarized transversely in the primary region and preferably longitudinally polarized in the secondary region.

In the apparatus indicated in the Itoh publication, only laminar discharges in small columns are possible due to the predetermined design. The oxygen is passed along the faces of the secondary region, specifically, within an annulus delimited externally by a cooling housing. With the apparatus described in the Itoh publication, it is not possible to implement applications beyond ozone generation. Even using the apparatus indicated in the Itoh publication, ozone generation is not particularly efficient. The apparatus of the Itoh publication has additional disadvantages that significantly restrict its application: First, no field control is possible. In addition, parasitic discharges occur at various sites that do not allow for any local or spatial control of the plasma discharge. Opportunities for large-area applications are thus eliminated. The described apparatus is also not suitable for “plasma-jet” technology in which a plasma is carried out of an orifice tube and projects beyond the contour of the plasma-generating apparatus.

Based on an apparatus as specified in the preamble of claim 1 as described in the cited Itoh publication, the problem to be solved by the invention is to further develop the known apparatus so as to provide improved plasma generation.

The invention solves this problem, first of all, with the features of claim 1, in particular, with those of the characterizing clause, and is accordingly characterized in that the secondary region comprises two partial regions that are oppositely polarized in the longitudinal direction.

The principle of the invention essentially consists in providing in the apparatus according to the invention a modified apparatus composed of piezoelectric material in which the secondary region now comprises two different partial regions that are of different polarity. At the same time, provision is made in a variant where the two partial regions are components of a unitary workpiece composed of piezoelectric material that have been differently polarized by a polarization technique that will be described below. Alternatively, the two partial regions can also be composed of separate workpieces composed of piezoelectric material, and provided adjacent each other, spaced relative to each other, or not spaced from each other.

In the case in which the two partial regions consist of a common differently polarized workpiece, it can be advantageous if a common primary region is associated with the two partial regions. The primary region is made to vibrate by applying a low AC voltage to the two electrodes. These vibrations are transmitted to the two partial regions of the secondary region. Due to the opposite directions of polarization for the two partial regions, electrical fields are generated along the surfaces of the two partial regions. The greatest potential difference and the greatest field strengths occur here between the two partial regions—specifically, in the area of the free ends of the secondary region, that is, in the area of the ends of the partial regions remote from the primary region. In the area of these free ends, an atmospheric-pressure plasma can be generated with a high degree of efficiency.

Within the meaning of this patent application, excitation of the primary region means that the low AC voltage has a frequency that corresponds to the resonance frequency of the apparatus composed of piezoelectric material. The resonance frequency is a function of the selected piezoelectric material, in particular, the velocity of sound in the piezoelectric material, and of the geometry of the primary region and the secondary region. Typical resonance frequencies are in a range between 10 and 500 KHz. Excitation of the primary region is also possible at a frequency whose wavelength is n times, or n×0.5 times, the resonance wavelength. Different modes of excitation are involved as a function of the selection of n.

With the apparatus according to the invention, an intense electrical field can be generated using a low AC voltage source at a predetermined site or in a predetermined region in order to generate a plasma. The high voltage is thus generated directly where the plasma requires the intense electrical fields. There is no longer any need for specially protected cables or wires to conduct the high voltage. In addition, it is possible to achieve especially compact, space-saving designs.

The piezoceramic itself is an insulator. It is thus true that potential differences can be tapped and measured along the surface of the secondary region. However, if one would, for example, take a finger and touch the outside of the secondary region, only such low charges would discharge here that there would be no danger of electrical shocks. As a result, only relatively low safety requirements would have to be met as compared with conventional apparatuses of prior art. The apparatuses according to the invention enable very high efficiencies, greater than 0.9, to be attained. In terms of design engineering, the result is an especially simple configuration due to the “natural” dielectric barriers present.

In an advantageous embodiment of the invention, the two partial regions are provided essentially parallel to each other. This provides an especially efficient generation of plasma.

In another advantageous embodiment of the invention, excitation of the primary region generates a potential difference between the two partial regions in a direction transverse to the longitudinal direction. As a result, intense electrical fields are generated in an area between the two partial regions, specifically to a high degree in an area near the connecting region between the two partial regions. This in particular enables the generation of a plasma in the area of the free ends of the secondary region, and thus basically the generation of large-area plasmas when multiple partial regions are provided along a line or along a plane. In addition, the generated fields can be determined very accurately beforehand.

The generation of potential differences between the two partial regions along a direction transverse to the longitudinal direction means, in particular, that the maximum potential differences are created in the area of the free ends of the partial regions. As a result, maximum electrical fields are generated there, thereby resulting in a preferred plasma generation in these regions.

In another preferred embodiment of the invention, the two partial regions are provided adjacent each other. This provides for a very compact design and enables strong potential differences to be achieved, and thus intense electrical field strengths to be achieved between the two partial regions.

In another advantageous embodiment of the invention, the two partial regions are not spaced relative to each other. This implementation allows for an especially simple design for the apparatus composed of piezoelectric material since the two partial regions of the secondary region are formed by a common workpiece that is differently polarized. The implementation of the polarization and the corresponding polarization method are described at a later point in this application. The embodiment of the invention provides an especially compact and simple design.

In another advantageous embodiment of the invention, the two partial regions are formed by a common workpiece that is polarized in different directions. This provides an especially simple design.

In another advantageous embodiment of the invention, the primary region and the secondary region are formed by a common workpiece that is polarized in at least three different directions. This provides an especially compact and simple design.

In another advantageous embodiment of the invention, the primary region and secondary region and/or the partial regions are formed by different workpieces that are attached to each other. This provides a modular-like design that allows, for example, the partial regions and the primary region to be initially polarized separately after fabrication, where assembly is only effected subsequent to this. Assembly can be done, for example, using suitable bonding means—for example, suitable adhesives. The critical factor is that the bond allow for transmission of resonance vibrations from the primary region to the secondary region. Suitable bonding means are known in the art.

In another advantageous embodiment of the invention, the two partial regions are slightly spaced apart relative to each other. This first of all enables an empty space to be provided between the two partial regions that can provide a mechanical and/or electrical decoupling of the partial regions. The empty space can also provide a gas flow channel that advantageously affects both the plasma generation, as well as a process or working gas for the plasma generation. Finally, the gas flow channel can also conduct the gaseous substrate to be treated.

In addition, an insulating element can also be provided in the empty space created between the two partial regions. An insulating gap of this type can ensure a mechanical, or optionally electrical, decoupling of the two partial regions, with the result that the formation of intense electrical fields or potential differences can occur only along specified predetermined regions. This increases the accuracy by which the areas in which the plasma is generated can be defined in advance.

In another advantageous embodiment of the invention, a separate primary region is associated with each partial region. This means that a first primary region is associated with a first partial region, and a second primary region is associated with a second partial region. Each of the two primary regions can have at least one individual pair of terminal electrodes, with the result that each primary region is supplied separately with AC voltage. This means that for the two primary regions at least three electrodes are provided. One electrode can be associated in common with both primary regions.

Of fundamental importance is the fact that the two primary regions are excited either phase-coincidentally or 180° phase-shifted, in any case in phase. This provides the efficient and controlled generation of intense electrical fields and large potential differences.

In another advantageous embodiment of the invention, a plurality of partial regions are oriented in a row, in particular, transverse to the longitudinal direction. This type of row configuration of partial regions can allow for a structural shape that is extended in a linear direction as desired. A separate primary region is advantageously associated with each partial region such that an empty space can be maintained between two partial regions. The number of electrode pairs can correspond to the number of partial regions. The polarization directions of the partial regions can alternate along the row. As a result, the generation of a plasma is possible between each two adjacent partial regions, preferably in the area of the free ends.

In another advantageous embodiment of the invention, a plurality of partial regions are oriented in a plane in the manner of a grid. This provides an especially large-area generation of plasma, and accordingly an especially large-area treatment of the substrate.

The invention furthermore relates to an apparatus for generating an atmospheric-pressure plasma as indicated in the preamble of claim 21.

The invention again is based on the above-referenced Itoh publication. The problem solved by the invention similarly consists in improving the generation of an atmospheric-pressure plasma.

The invention solves this problem with the features of claim 21, in particular, with those of the characterizing clause, and is characterized in that the secondary region is composed of two separate partial regions that are polarized along the same polarization direction, that a separate primary region is associated with each partial region, and that the two primary regions are provided in a push-pull fashion. In this manner, an excitation of the two primary regions generates a potential difference between the two partial regions in a direction transverse to the longitudinal direction.

The principle of this invention is best understood in analogy to a consideration of the above-described functional principle of an apparatus as specified in claim 1.

Whereas in claim 1 two oppositely polarized partial regions of the secondary region are provided, this invention employs two separate partial regions that are polarized along the same polarization direction. However, these are excited in a push-pull fashion, which action can be effected by various means. A push-pull configuration of the two primary regions means, e.g. that both primary regions are polarized along the same polarization direction and phase-displaced 180°, but are excited in phase, i.e. in constant phase. Alternatively, the two primary regions can also be excited along opposite polarization directions and phase-coincidentally, i.e. without phase shift, in phase. The critical point is that the primary regions vibrate synchronously but with a 180° phase shift such that the two separate partial regions of the secondary region also vibrate with constant phase but oppositely relative to each other. As a result, comparably intense electrical field strengths are generated between the two partial regions that promote the generation of atmospheric pressure plasmas.

A push-pull configuration of the two primary regions comprises both described alternatives for the selection of the polarization directions of the primary regions and the corresponding associated electrode geometry, as well as the associated voltage supply lines.

The two separate partial regions, and, e.g. similarly as well the two associated primary regions, can be spaced apart and have between them either an empty space, in particular, in the form of gas flow channel, or an insulator. In the case of a gas flow channel between the two partial regions, plasma generation can also occur within the gas flow channel. If an insulator is located between the two partial regions, plasma generation is preferably effected at the free end face of the partial regions, in particular, along the connecting surfaces of along the interfaces between the two partial regions.

In an advantageous embodiment of the invention, the two primary regions have a coincident polarization direction and are excitable 180° phase-displaced. Phase-displaced excitation means that the two primary regions are excited in a fixed constant phase relative to each other, where a phase shift of 180° is provided. In this alternative, the two primary regions can be polarized along the same polarization direction.

Alternatively, the two primary regions have opposite polarization directions and are excitable phase-coincidentally, i.e. without phase shift, in phase.

In an advantageous embodiment of the invention, each of the two primary regions has a pair of electrodes. This means that each primary region can have as separate pair of electrodes. Alternatively, an arrangement can be provided in which one of the electrodes is associated with the two primary regions, and in which this electrode is provided between the two primary regions.

Advantageously, one primary region and one partial region each are formed by a common workpiece. This provides an especially simple design.

Also advantageously, the two partial regions are spaced slightly apart. This enables an insulating element to be provided between the two partial regions, or alternatively, a gas flow channel to be provided between the two partial regions.

In an advantageous embodiment of the invention, a plurality of partial regions are oriented in a row, in particular, transverse to the longitudinal direction. This enables an apparatus to be constructed having a plurality of plasma-generating regions, thereby providing overall very-large-area treatment of a substrate.

In an advantageous embodiment of the invention, the push-pull configuration of the associated primary regions alternates along the row of partial regions. This means that a plurality of partial regions are oriented, for example, along the row directly adjacent or spaced apart, and all partial regions have the same polarization direction. In order to be able to generate potential differences transverse to the longitudinal direction, the primary regions associated with the individual partial regions must vibrate synchronously but 180° phase-shifted. This means that in each case two adjacent primary regions are provided in push-pull fashion relative to each other. Once again, this can be accomplished by two different alternative embodiments. In a first alternative, the two adjacent primary regions are polarized along the same polarization direction, but excited 180° phase-shifted. In a second alternative, the primary regions have opposite polarization directions and are excited phase-coincidentally, i.e. without phase shift, in phase.

In an advantageous embodiment of the invention, a plurality of partial regions are oriented in a plane in the manner of a grid. This provides an especially large-area treatment of the substrate. In this embodiment of the invention, the push-pull configuration of associated primary regions can alternate along a first direction and along a second direction. The apparatus described with reference to claims 33 and 34 can thus be converted from the described one-dimensional configuration to a two-dimensional configuration.

In addition, the invention relates to an apparatus for generating an atmospheric-pressure plasma as specified in the preamble of claim 37.

Again, the invention is based on an apparatus as described in the above-referenced Itoh publication.

The problem solved by the invention similarly consists in further developing the known apparatus so as to provide an improved and in particular a more efficient generation of plasma.

The invention solves this problem with the features of claim 37, in particular, with the features of the characterizing clause, and is accordingly characterized in that a second unit is provided including a second separate primary region and including a second separate secondary region extending in the longitudinal direction, that the two secondary regions are provided parallel to each other and spaced apart transverse to the longitudinal direction, and that the two secondary regions form a gas-carrying channel between themselves running in the longitudinal direction.

The principle of the invention essentially consists in disposing two secondary regions in a direction transverse to the longitudinal direction of the secondary regions, spaced apart but parallel to each other. In this way, the two secondary regions can form a gas-carrying channel between them running in the longitudinal direction. A separate primary region is associated with each of the two secondary regions. The gas-carrying channel advantageously also extends between the two separate primary regions.

The two primary regions are excited in fixed phase relative to each other phase-coincidentally, or alternatively 180° phase-displaced. To this end, each of the two primary regions is provided with a pair of electrodes to which a low AC voltage is applied. The two primary regions are excited synchronously—which means that the two primary regions are polarized along the same polarization directions, and disposed in phase, either phase-coincidentally or 180° phase-displaced. Alternatively, the primary regions can also be polarized along different directions, in particular, along opposite directions.

The critical factor is that a gas flow can be passed through between the two secondary regions, which gas flow can be modified by the electrical fields that form between the two secondary regions. Due to the potential differences, the electrical fields can form that extend either in the longitudinal direction of the respective secondary regions, or transverse to this longitudinal direction. The spatial distribution of the electrical field lines is essentially dependent on how the secondary regions are polarized, specifically, whether two opposing secondary regions are polarized along the same polarization direction or along opposite polarization directions. Both alternatives are possible.

Essential to the functional principle of this invention is that two opposing secondary regions are provided such that very-precisely-determinable electrical field geometries are produced wherein the electrical fields are superposed and amplified. Plasma generation in the area between the two partial regions of the secondary region is promoted due to the synchronous excitation of the associated primary regions and by a corresponding synchronous generation of electrical fields along the opposing secondary regions.

In an advantageous embodiment of the invention, a plurality of secondary regions is disposed in a straight row and forms between these a plurality of gas-carrying channels running in the longitudinal direction. This provides the generation of large-volume or large-area plasmas.

In another embodiment of the invention, a plurality of secondary regions are oriented in a plane, in particular, in the manner of a grid, and forms between these a plurality of gas-carrying channels. This enables an especially large-volume or an especially large-area plasma to be generated, and similarly enables large-area or large-volume substrates to be treated.

The invention additionally relates to an apparatus for generating an atmospheric-pressure plasma as specified in the preamble of claim 40. Again, the invention is based on the above-described Itoh publication.

The fundamental problem solved by the invention is to further develop the known apparatus such that an improved generation of plasma becomes possible.

The invention solves this problem with the features of claim 40, in particular with those of the characterizing clause, and is accordingly characterized in that the secondary region has a curved inner surface that forms a wall of a gas-carrying channel.

The principle of the invention essentially consists in providing the secondary region with a curved shape. Due to the curvature, the secondary region obtains a curved inner surface. The inner surface, according to the invention, provides the wall of a gas-carrying channel. A working or process gas can thus be passed directly along the surface of the secondary region, whereby an enlarged surface is achieved due to the curvature. As a result, a generation of plasma in greater volumes or along an enlarged surface can be attained, or an improved interaction between the gas and the plasma can be achieved. The electrical field lines running along the curved inner surface, in contrast to the prior art, promote the generation of plasma.

In particular, this apparatus offers the ability to completely eliminate separate vessels for carrying a gas for the plasma-generating sections. The vessel required for the prior art that can detrimentally affect the pattern of the electrical field lines can now be provided by the secondary region itself, without producing any detrimental effect.

The inner surface is preferably curved around a line of curvature that essentially extends in the longitudinal direction of the secondary region. As a result, the gas flow as well can be passed along the longitudinal axis.

Preferably, the primary region is radially polarized. This means that the polarization direction in the primary region is directed toward the line of curvature or away from this line.

In an advantageous embodiment of the invention, the curved inner surface represents a boundary surface for the atmospheric-pressure plasma. As a result, the need for separate boundary surfaces is eliminated.

The invention additionally relates to an apparatus for generating an atmospheric-pressure plasma as specified in the preamble of claim 42.

Again, the invention is based on the above-described Itoh publication.

The fundamental problem solved by the invention is to further develop the known apparatus such that an improved generation of plasma becomes possible.

The invention solves this problem with the features of claim 42, in particular with those of the characterizing clause, and is accordingly characterized in that a continuous gas flow channel running in the longitudinal direction is provided in the secondary region, and that the secondary region completely encircles the gas flow channel.

The principle of the invention essentially consists in the secondary region's having a continuous opening that forms a gas flow channel. The secondary region encircles the gas flow channel completely. The secondary region can also have an orifice region for a plasma jet. Within the gas flow channel, plasma can be generated to which a plasma jet can also be linked behind the orifice of the gas flow channel, depending on various parameters such as, for example, the flow velocity of the gas. To this end, the orifice region can also be designed so as to be nozzle-shaped.

Especially advantageous is the fact that vessels for supplying the gas flow channel can be completely eliminated. The walls of the passage opening in the secondary region can directly provide the walls of the gas flow channel. As a result, an especially advantageous and optimized generation of a plasma becomes possible using a simple design.

In an advantageous embodiment of the invention, the gas flow channel also passes through the primary region. As a result, it is possible for the apparatus to have a honeycomb structure that ideally can be fabricated from a single workpiece. The fabrication of such a honeycomb structure will be described below.

If the gas flow channel also passes through the primary region, the primary region is preferably also radially polarized. This means that the polarization direction in the primary region is directed toward the center or a center line of the gas flow channel, or away from this line.

This polarization can be effected in the simplest conceivable manner by applying electrodes to the inside of the gas-carrying channel and to the outside of the gas-carrying channel.

In an advantageous embodiment of the invention, the apparatus essentially is of a tubular design. Such a structure provides an especially simple design.

A plurality of corresponding tubular apparatuses can, for example, be combined in a linear configuration or along a plane, forming a grid. This also provides honeycomb structures that can generate large-area or large-volume plasmas.

The invention additionally relates to an apparatus for generating an atmospheric-pressure plasma as specified in the preamble of claim 46.

Again, the invention is based on the above-described Itoh publication.

The fundamental problem solved by the invention is to provide an improved and more efficient generation of atmospheric-pressure plasma.

The invention solves this problem with the features of claim 46, in particular with those of the characterizing clause, and is accordingly characterized in that multiple continuous parallel gas flow channels running in the longitudinal direction are provided in the secondary region.

The principle of the invention essentially consists in providing a plurality of gas flow channels in the secondary region. The gas flow channels run in the longitudinal direction of the secondary region such that the gas flow is also effected along the direction along which potential differences are created. The gas flow channels lead to a honeycomb structure of the secondary region. This provides an especially simple and compact design for the apparatus according to the invention, as well as an especially large-area and large-volume plasma generation.

The invention additionally relates to a workpiece composed of piezoelectric material as specified in the preamble of claim 47.

Again, the invention is based on the above-described Itoh publication in which a workpiece as specified in the preamble of claim 1 is described.

Based on the known apparatus, the problem solved by the invention consists in further developing the known workpiece such that it is treatable in an especially simple manner, and is specifically well-suited for generating an atmospheric-pressure plasma.

The invention solves this problem with the features of claim 47, in particular with those of the characterizing clause, and is accordingly characterized in that the workpiece has at least three zones of different polarization.

The principle of the invention essentially consists in subdividing the workpiece into a plurality of zones of different polarization. Whereas the known workpiece has only two zones of different polarization, what is provided according to the invention is that at least three zones of different polarization are provided. As a result, a primary region can be provided that is polarized along a first polarization direction, and a secondary region can be provided having two partial regions that are polarized in the longitudinal direction of the secondary region, that is, transverse to the polarization direction of the primary region—however, along opposite polarization directions. As a result, an especially simple fabrication of a workpiece is provided that can be employed in an apparatus for generating an atmospheric-pressure plasma.

The invention additionally relates to a method of polarizing a unitary workpiece composed of piezoelectric material as specified in the preamble of claim 48.

No such method has been disclosed in printed publications. The above-described Itoh publication does describe a workpiece that is designed as a Rosen-type PT. The polarization of a workpiece is effected to fabricate a Rosen-type PT in which two electrodes are applied to a primary region. One polarization is implemented along a first polarization direction. To this end, high polarization voltages in the kilovolt range are applied across the two electrodes. Subsequently, these two electrodes are set to the same potential and a third electrode is applied to the end face of the secondary region. A polarization voltage in the kilovolt range is then again applied between this electrode and the two previously attached electrodes. This results in achieving a polarization in a polarization direction within the secondary region transverse to the polarization direction of the primary region, that is, in the longitudinal direction of the secondary region.

In the method according to the invention, realization of three different polarization zones in a unitary workpiece is provided. As a result, it is possible to fabricate a workpiece that has two partial regions of a secondary region with opposite polarization. This provides an especially convenient polarization of the workpiece.

The invention additionally relates to a method of fabricating a unitary honeycomb workpiece from piezoelectric material as specified in the preamble of claim 51. No such method is known to the applicant from the standard prior art.

The problem solved by the invention consists in providing a method by which a honeycomb workpiece can be fabricated by simple means.

The invention solves this problem with the features of claim 51.

What is accordingly provided is to realize the fabrication of the workpiece in the manner of an extrusion process. Accordingly, the piezoelectric material is continuously delivered from a nozzle, coming from an extruder. The nozzle, in other words, the discharge apparatus for the piezoelectric material has a counter-honeycomb-structure complementary to the honeycomb structure of the workpiece to be fabricated, which counter-honeycomb-structure provides a plurality of mandrels. As a result, the workpiece is produced with passage openings running in the longitudinal direction. The material can be trimmed to the desired length, whereby the passage openings can subsequently provide the gas flow channels of the workpiece.

In order to attach the electrodes, the trimmed honeycomb structure composed of piezoelectric material can be immersed longitudinally in a electrode dipping bath. In this way, the electrodes can be attached to the honeycomb structure. Subsequently, polarization can be effected. The secondary region can be polarized in a second polarization step.

The passage openings can have any desired cross-section—for example, a square cross-section.

Additional advantages of the invention will become evident based on the uncited dependent claims and on the following description of numerous illustrated embodiments shown in the figures. In the figures:

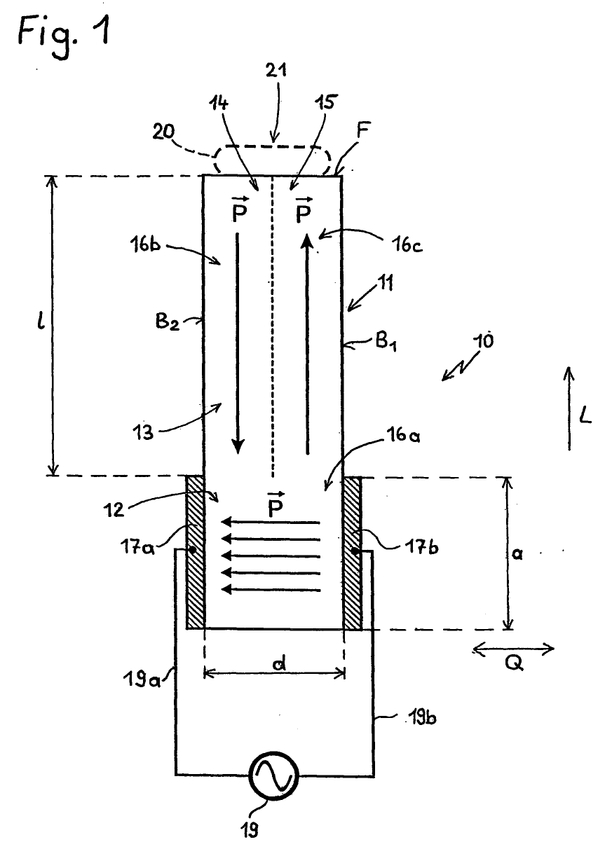

FIG. 1 is a schematic sectional view of a first embodiment of the apparatus according to the invention comprising a secondary region that is subdivided into two partial regions polarized in opposite directions;

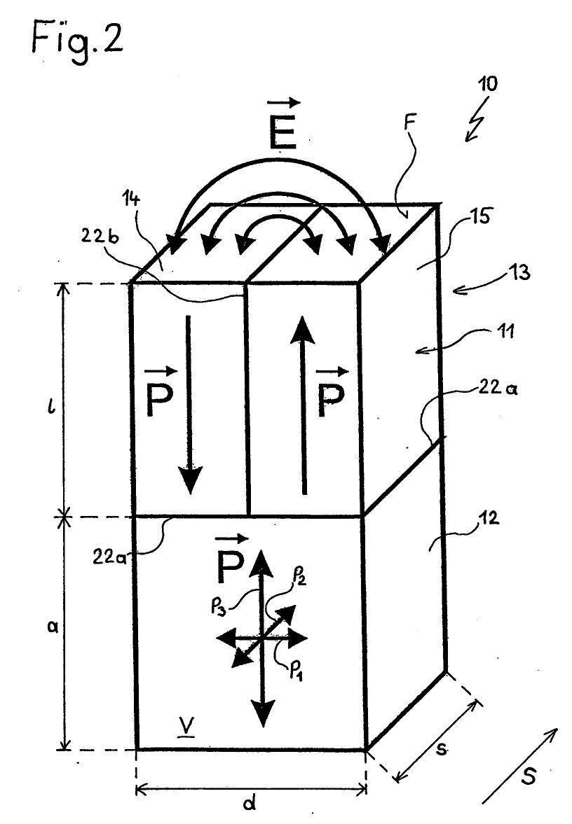

FIG. 2 shows the apparatus of FIG. 1 in a perspective view, the electrodes and the voltage supply source having been omitted for the sake of clarity, and wherein the primary region and the two partial regions of the secondary region are formed by separate elements;

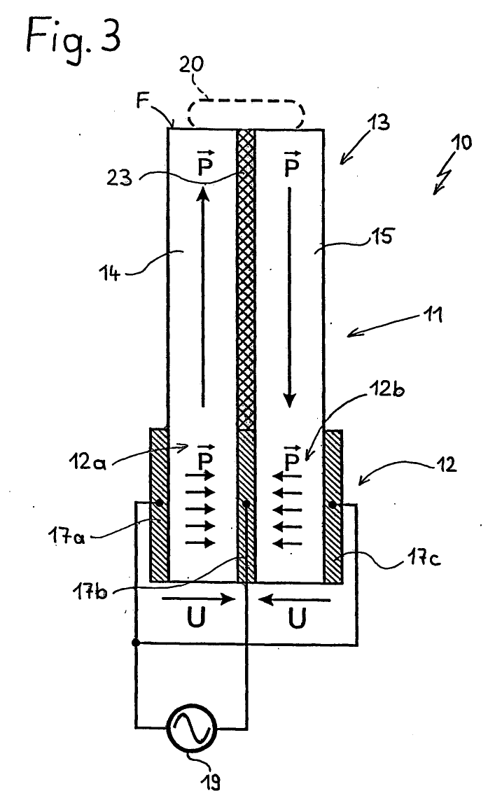

FIG. 3 shows as in FIG. 1 a second embodiment of the apparatus according to the invention, where an insulating gap is provided between the two partial regions of the secondary region, and wherein a separate associated primary region is associated with each partial region of the secondary region;

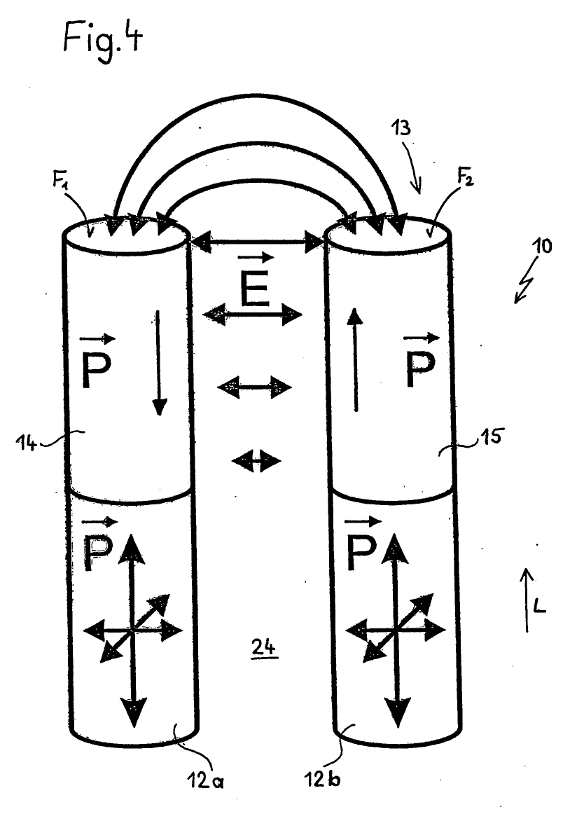

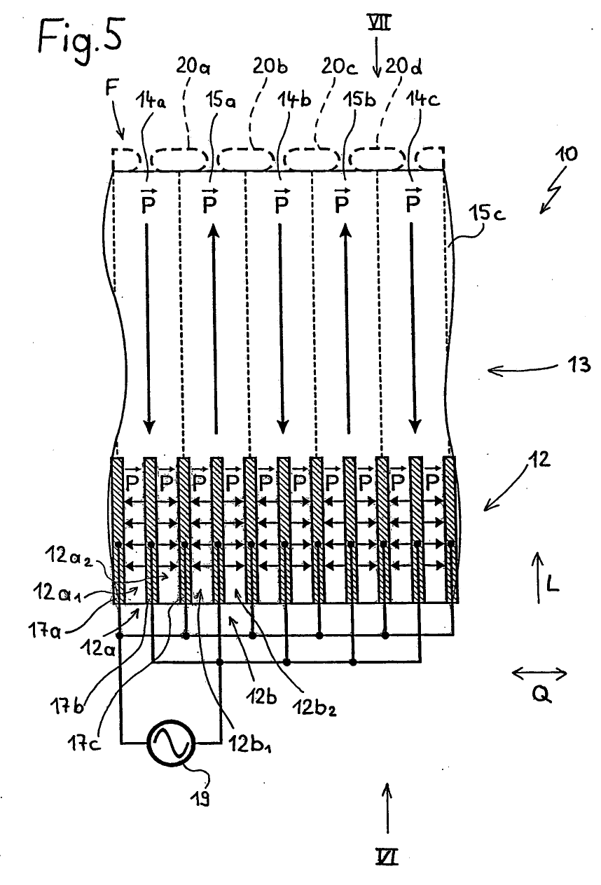

FIG. 4 is a schematic view showing another embodiment of the apparatus according to the invention in which the two partial regions of the secondary, and the two associated primary partial regions are spaced apart by an empty space;

FIG. 5 shows a row configuration of partial regions of the secondary region in a view based on FIG. 1, a separate primary region subdivided into primary partial regions being associated with each partial region;

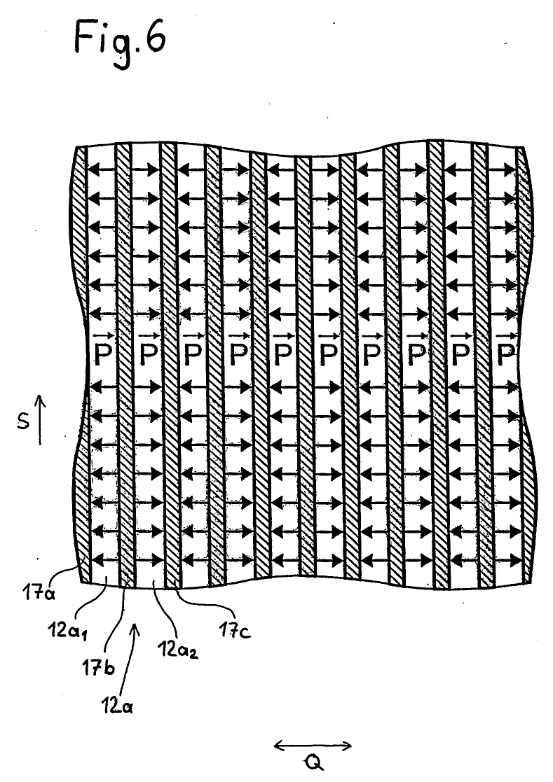

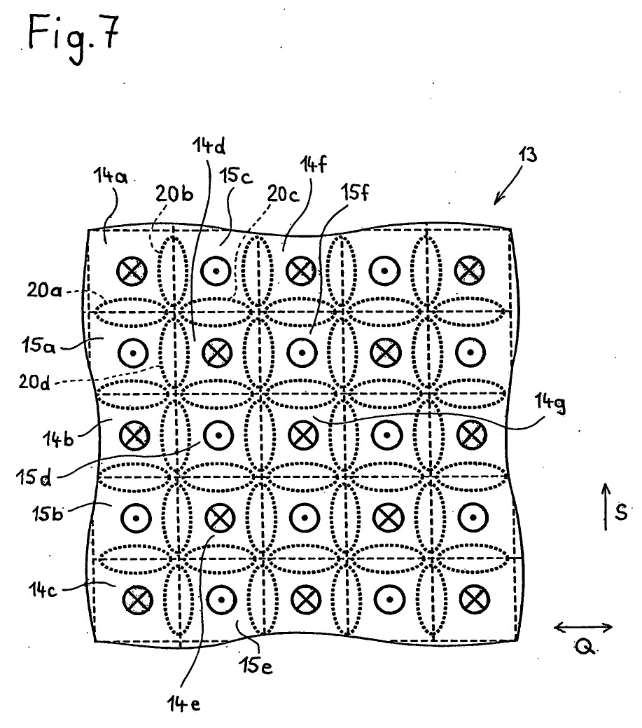

FIG. 6 shows the apparatus of FIG. 5 in a bottom view indicated by the directional-view arrow VI in FIG. 5;

FIG. 7 shows another embodiment of the apparatus according to the invention in a top view of the plasma-generating top side, wherein a plurality of partial regions of the secondary region are oriented in a straight line;

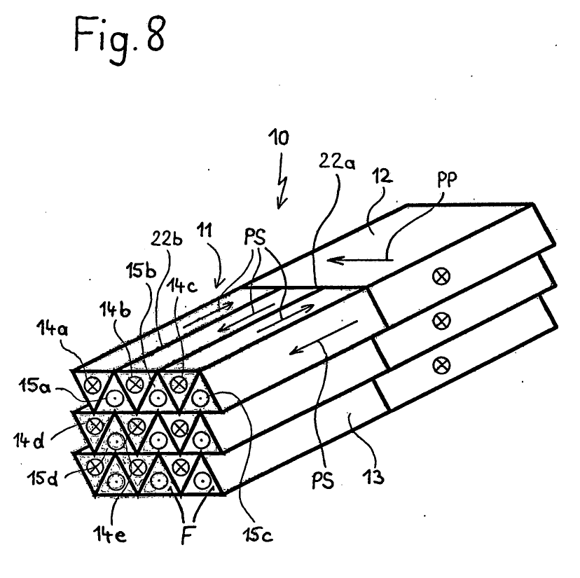

FIG. 8 shows another embodiment of the apparatus according to the invention in which the partial regions of the secondary region are formed by rod-shaped bodies of triangular cross-section;

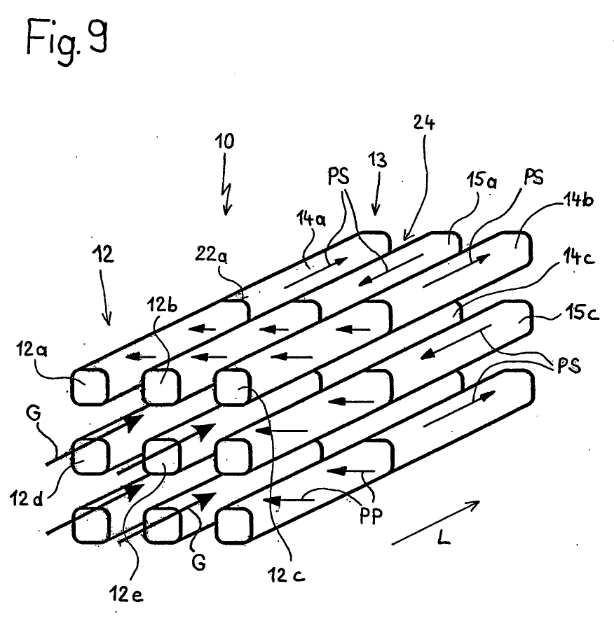

FIG. 9 shows another embodiment of the apparatus according to the invention in a view based on FIG. 8, a separate primary region being associated with each partial region, and wherein the partial regions and the primary partial regions are formed from the rod-shaped bodies having essentially a square cross-section, wherein each rod-shaped body is spaced relative to an adjacent rod-shaped body;

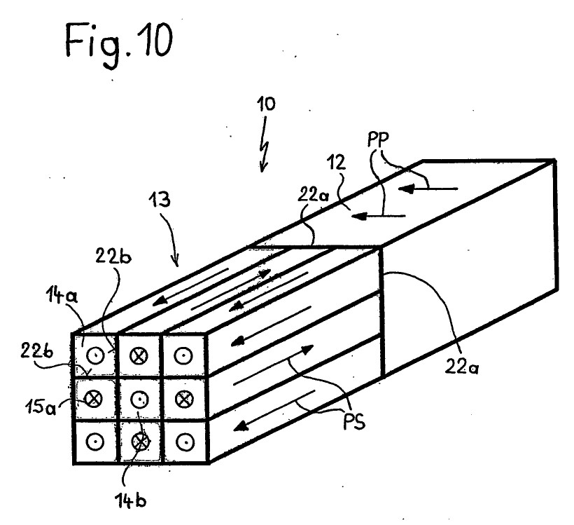

FIG. 10 shows another embodiment of the apparatus according to the invention comparable with the apparatus of FIG. 9, the rod-shaped bodies not being spaced relative to each other;

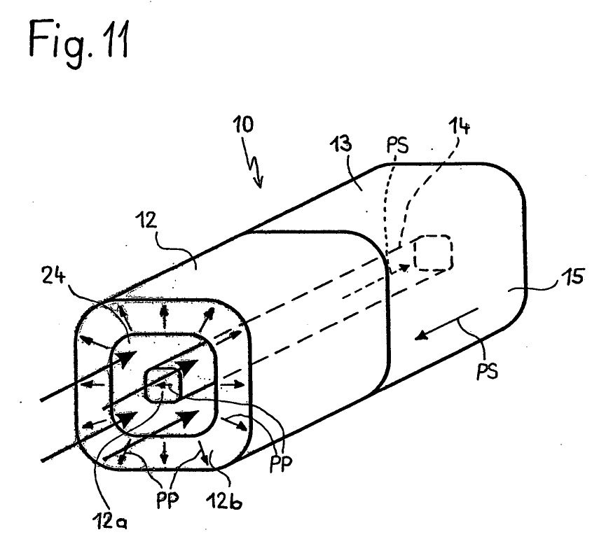

FIG. 11 shows another embodiment of the apparatus according to the invention in a view based on FIG. 9, a single centrally provided rod-shaped body being provided that is surrounded by an annular body with a square cross-section while leaving an annular space;

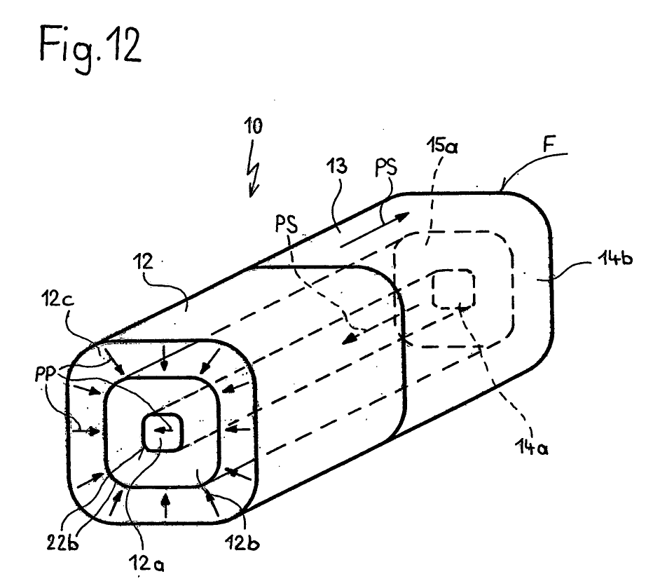

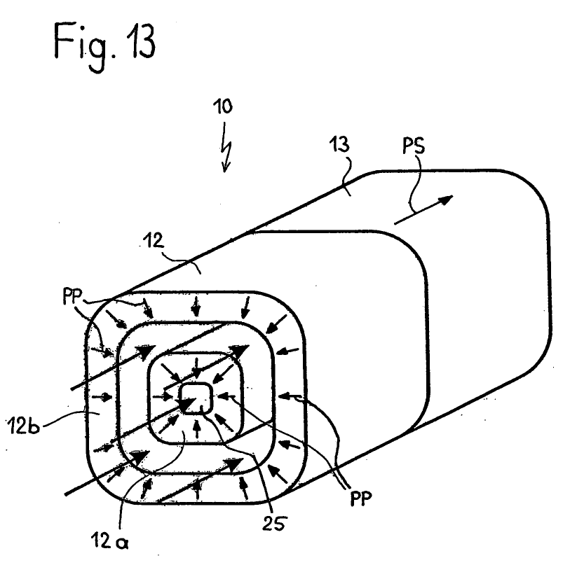

FIG. 12 shows another embodiment of the apparatus according to the invention in a view based on FIG. 11, three concentrically disposed bodies being provided directly against each other;

FIG. 13 shows another embodiment of the apparatus according to the invention comparable to the embodiments of FIGS. 11 and 12, where, in contrast to the view of FIG. 11, the central body in this embodiment itself has a passage opening;

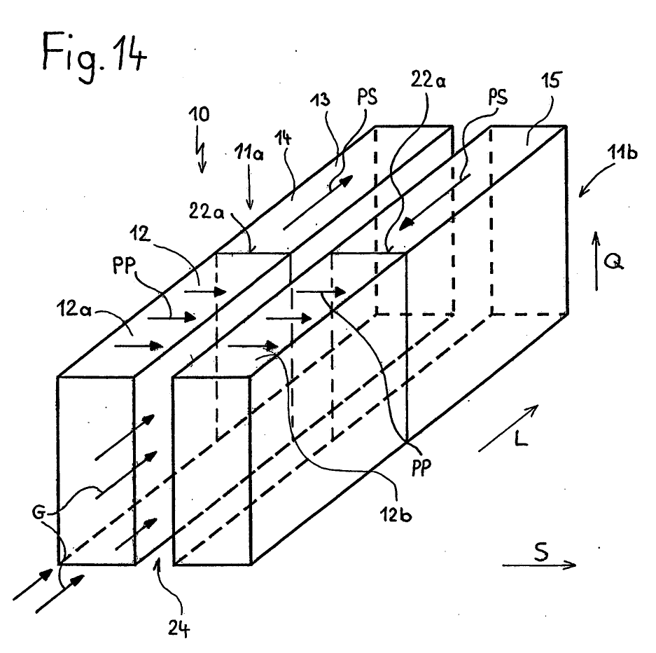

FIG. 14 shows another embodiment of the apparatus according to the invention in which two essentially parallepipedal bodies are spaced apart such that the two primary partial regions and the two partial regions of the secondary region form a gas flow channel between them;

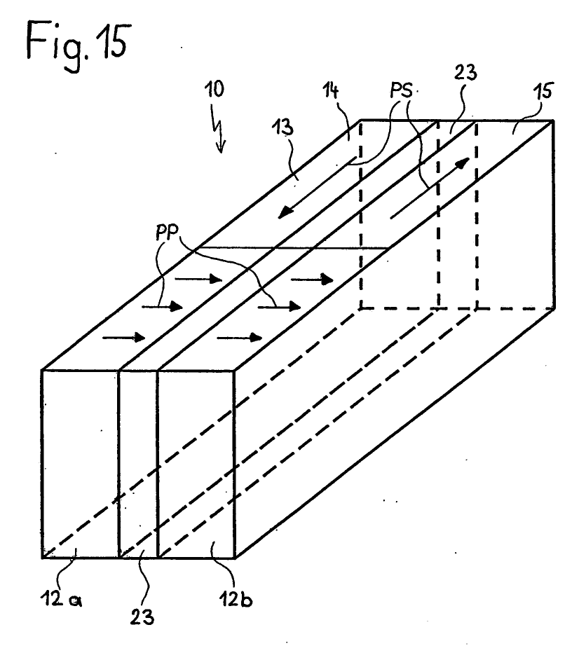

FIG. 15 shows as in FIG. 14 another embodiment of invention in which an insulating gap is provided between the two parallepipedal bodies;

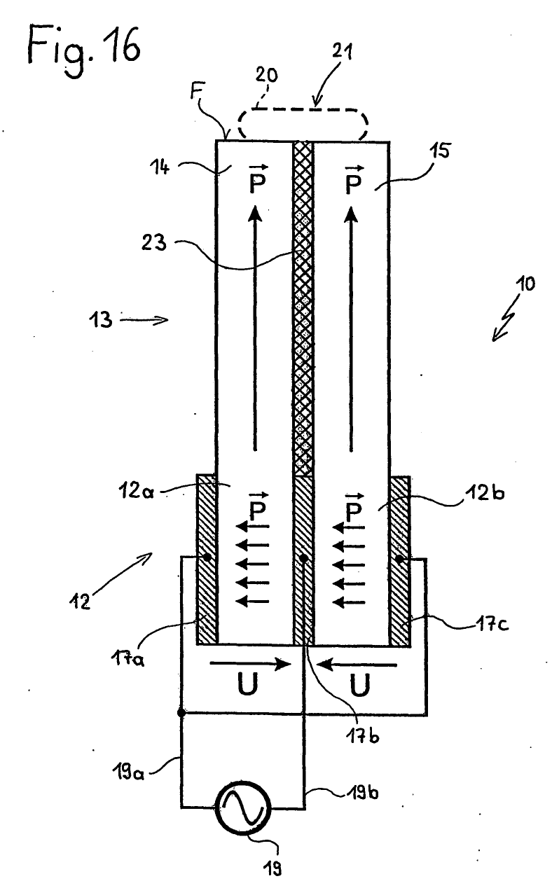

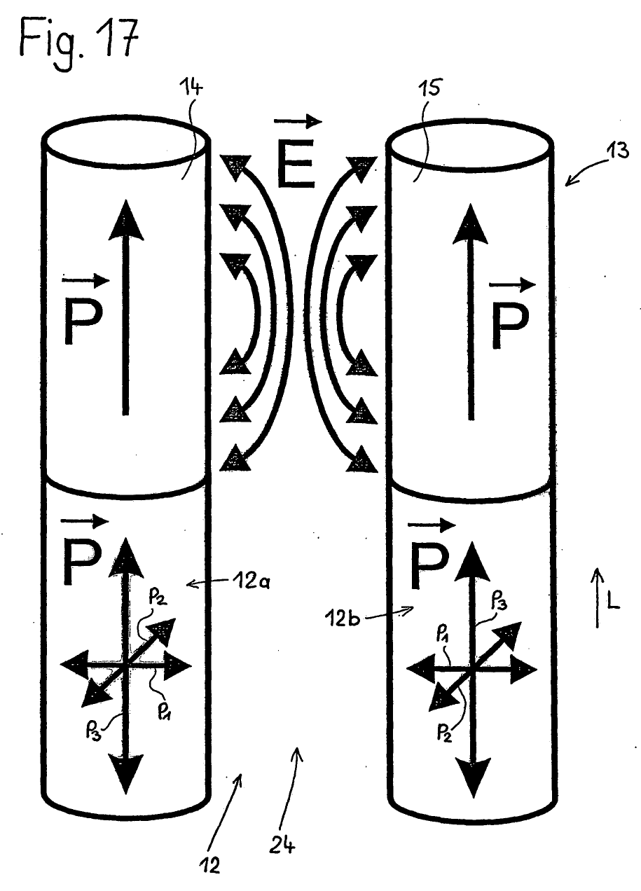

FIG. 16 shows another embodiment of the apparatus according to the invention comprising two partial regions of a secondary region that are polarized along the same polarization direction;

FIG. 17 shows another embodiment of the apparatus according to the invention in which an empty space is provided between the two secondary regions and the associated primary partial regions;

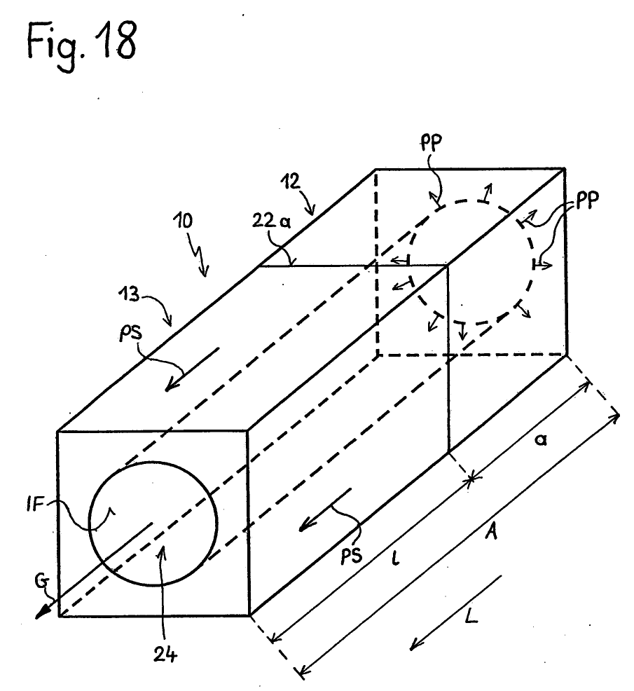

FIG. 18 shows another embodiment of the apparatus according to the invention comprising a central passage opening;

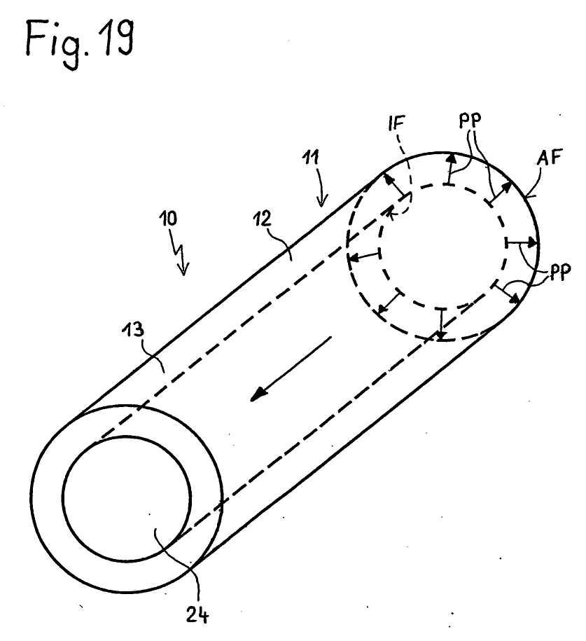

FIG. 19 shows another embodiment of the invention comparable to the embodiment of FIG. 18;

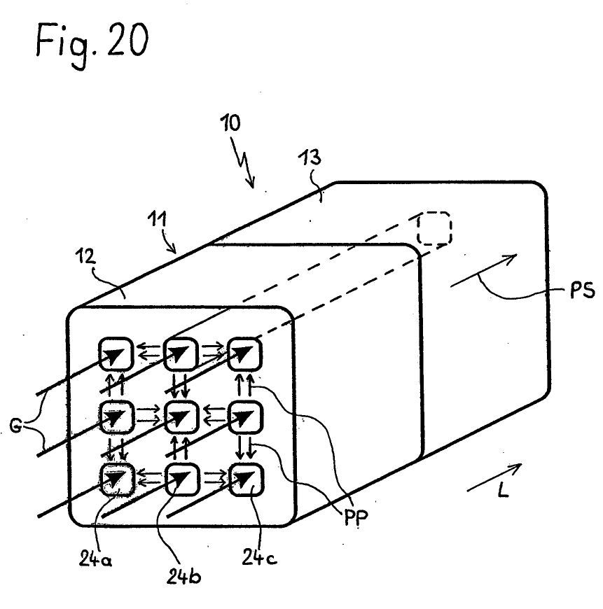

FIG. 20 shows another embodiment of the apparatus according to the invention comprising a plurality of passage openings;

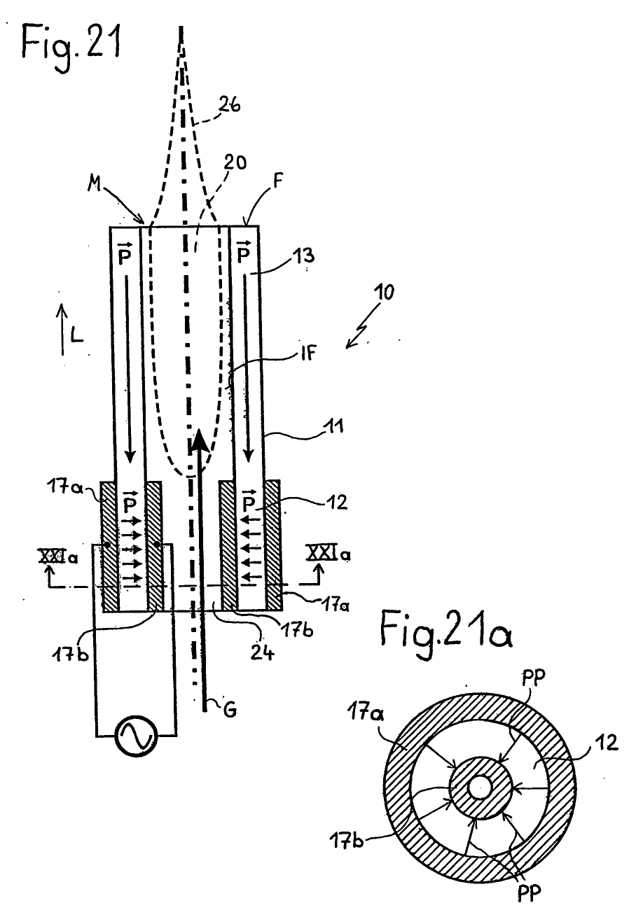

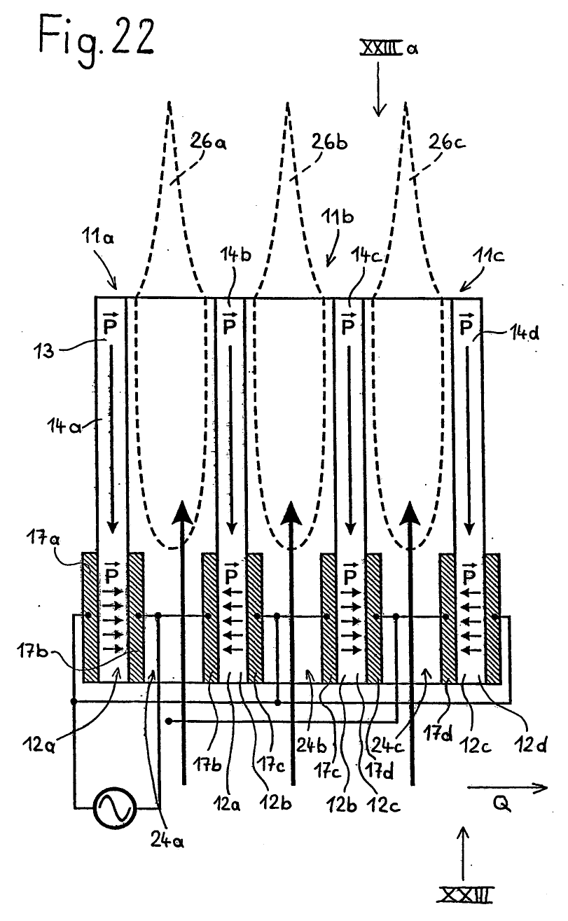

FIG. 21 shows another embodiment of the apparatus according to the invention comprising an essentially almost tubular, cylindrical apparatus for generating a plasma jet;

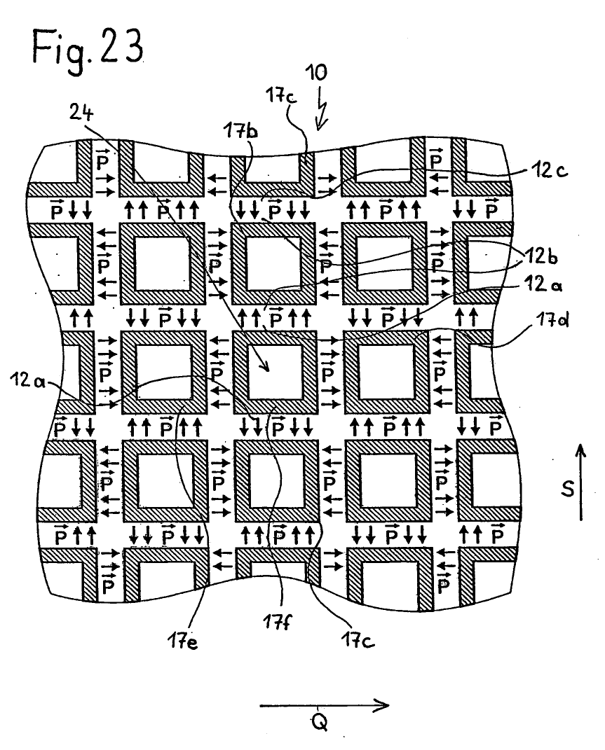

FIG. 22 shows a multi-plasma-jet source in a view based in FIG. 21;

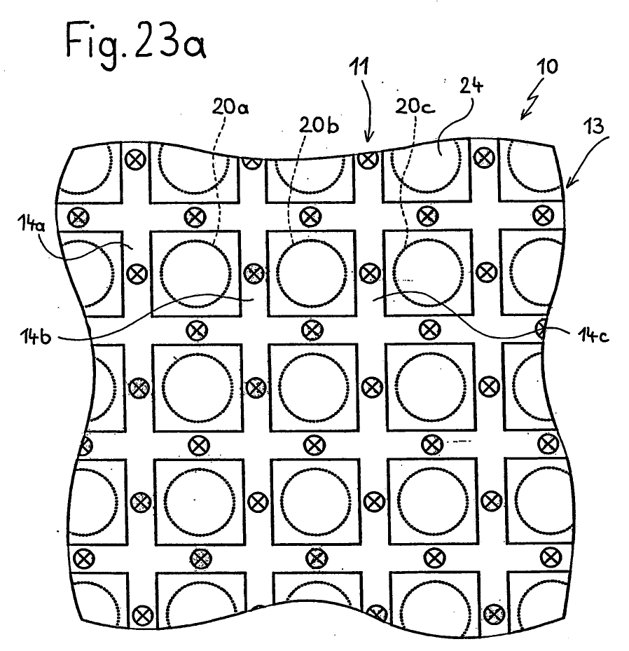

FIG. 23 shows an apparatus based on FIG. 22 in a bottom view approximately indicated by directional-view arrow XXIII in FIG. 22;

FIG. 23a is a top view of the apparatus indicated by directional-view arrow XXIIIa in FIG. 22;

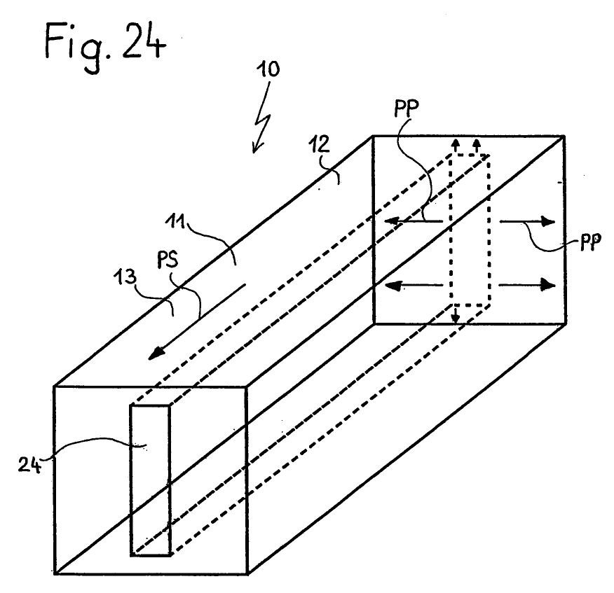

FIG. 24 shows another embodiment of the apparatus according to the invention;

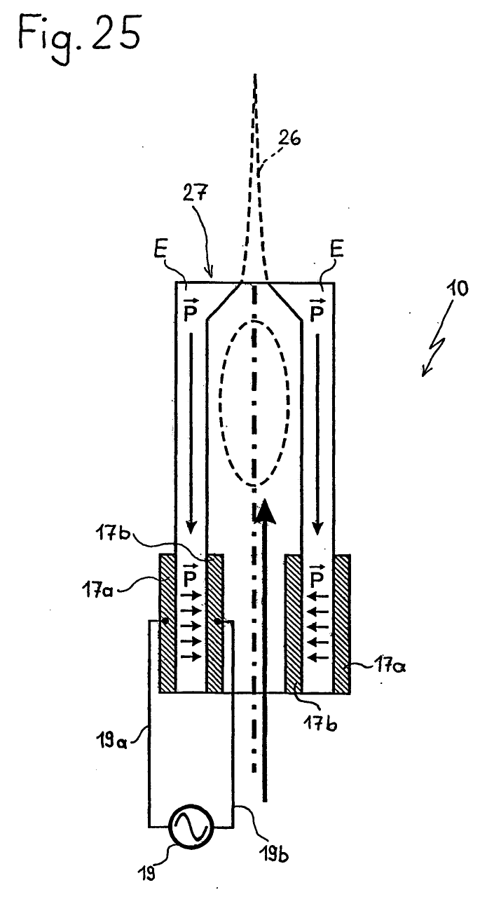

FIG. 25 shows another embodiment of the apparatus according to the invention comprising a nozzle-like tapered gas flow channel;

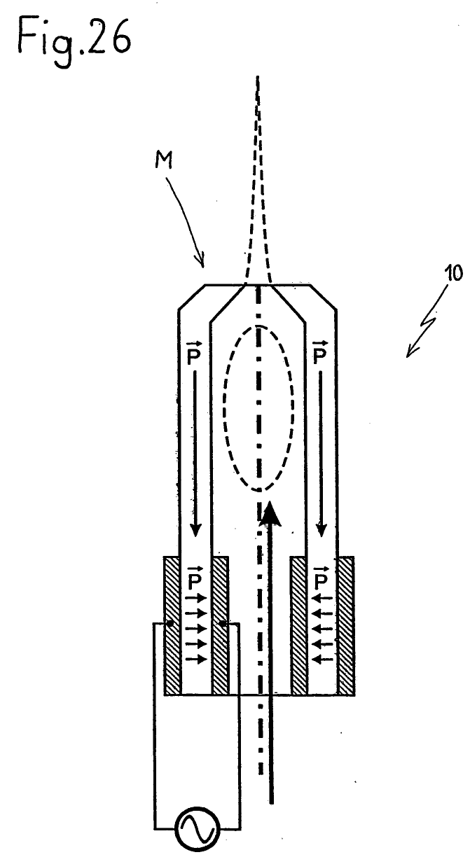

FIG. 26 shows another embodiment of the apparatus according to the invention;

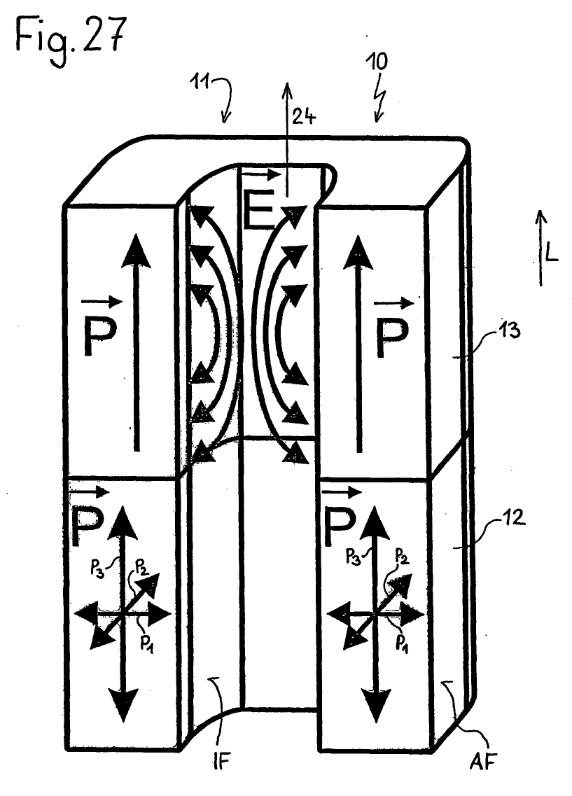

FIG. 27 shows another embodiment of the apparatus according to the invention illustrating the basic physical principle;

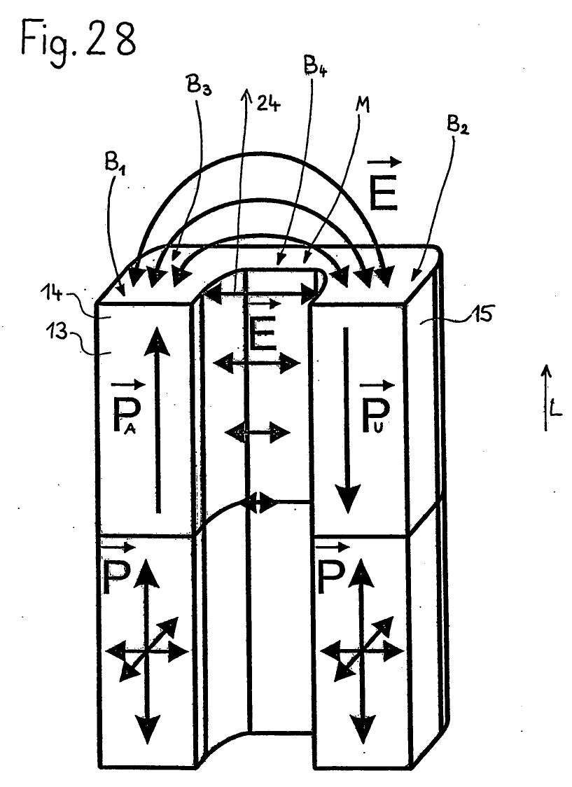

FIG. 28 shows another embodiment of the apparatus according to the invention illustrating another basic physical principle;

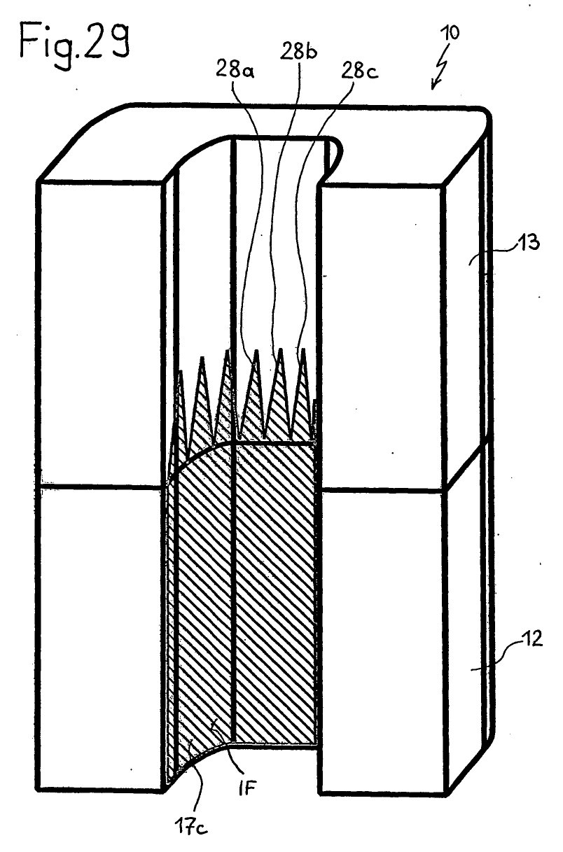

FIG. 29 shows another embodiment of the apparatus according to the invention comprising a special internal electrode.

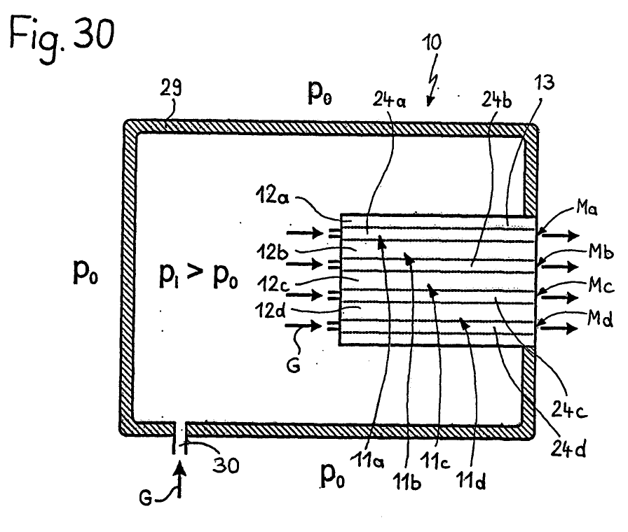

FIG. 30 shows another embodiment of the apparatus according to the invention comprising a housing;

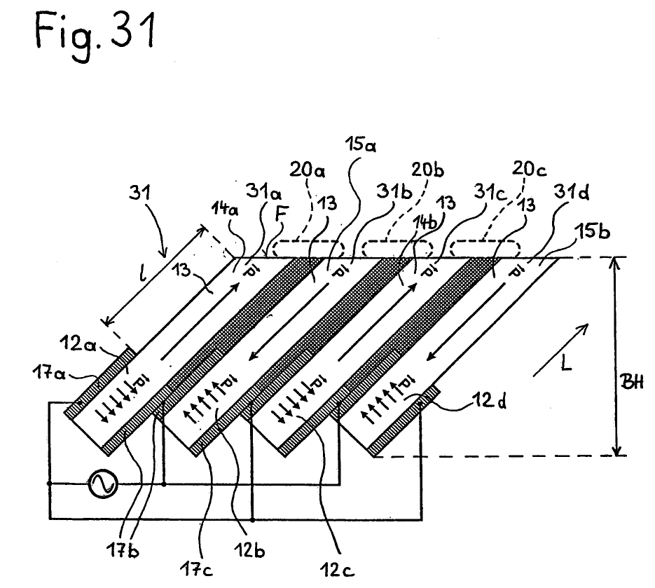

FIG. 31 shows another embodiment of the apparatus according to the invention comprising an obliquely oriented layer structure configuration, the individual layers being composed, for example, of laminated ceramic films with imprinted electrodes

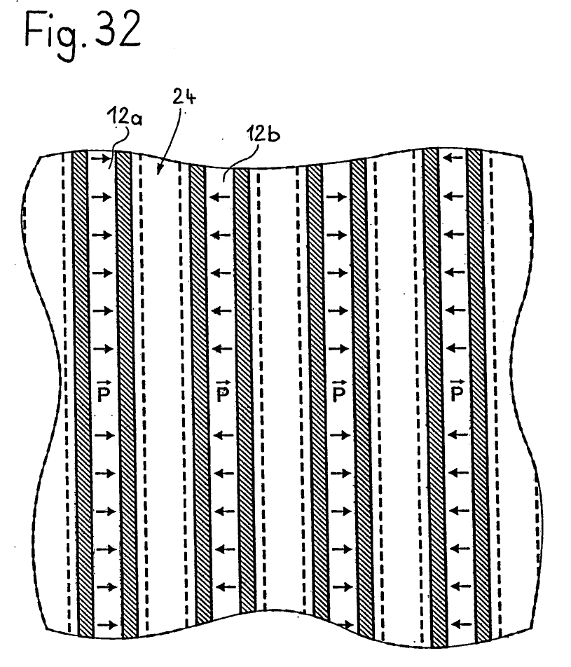

FIG. 32 shows another embodiment of the apparatus according to the invention in a bottom view similar to the view of FIG. 6;

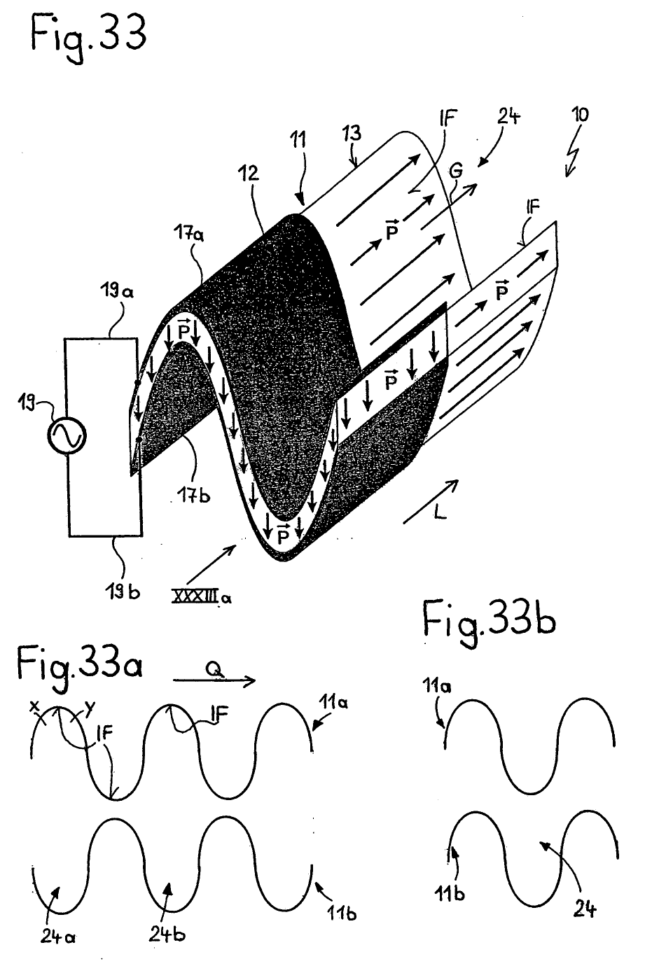

FIG. 33 shows another embodiment of the apparatus according to the invention in a schematic part-sectional perspective view in the manner of a corrugate structure;

FIG. 33a shows another embodiment of the apparatus according to the invention comprising two schematically shown corrugated structures approximately in a front view indicated by directional-view arrow XXXIIIa in FIG. 33; and

FIG. 33b shows another embodiment similar to FIG. 33a in which the two corrugated structures are parallel to each other.

The apparatus for generating a plasma according to the invention as identified in its entirety by 10 will first be described based on FIG. 1 in terms of its basic principle with reference to a first variant of the invention. It should be noted in advance that for the sake of clarity in the following description of the figures, including with respect to different embodiments, identical or analogous or functionally equivalent parts or elements are identified by the same reference notations and by the same characters, in part with the addition of small-case appended characters.

FIG. 1 shows a first embodiment of the apparatus according to the invention that comprises a unit 11 composed of piezoelectric material. Possible piezoelectric materials considered include appropriate materials exhibiting a piezoelectric effect such as, for example, PXE ceramics such as lead zirconate titanate Pb(ZrTi)O₃.

Unit 11 can, for example, be formed from a single workpiece that is subdivided into three zones 16a, 16b, 16c with different polarization. The polarization directions are indicated by arrows P.

One polarization direction for a piezoelectric material is generated by applying a polarization voltage such that all of the Weis-type dipole regions in the material flip over due to the applied voltage or in the direction determined by the electrode geometry. The polarization direction is thus determined by the shortest geometric connection between the two applied electrodes and their polarity.

As indicated in FIG. 1, unit 11 has a primary zone 12 or a primary region with essentially polarization direction P running in transverse direction Q, and secondary zone 13 or secondary region with polarization directions running in or opposite to the longitudinal direction L.

Unit 11 of FIG. 1 can, for example, have the shape of a parallepipedal that extends vertically to the plane of the paper along a line segment s that is, for example, greater than width d of unit 11.

Essentially plate-like electrodes 17a and 17b are applied to the correspondingly formed faces B1 and B2 of unit 11 in primary region 12. The electrodes can, for example, be imprinted, deposited by sputtering, or attached in other appropriate ways.

The two electrodes 17a and 17b are connected through voltage supply lines 10a and 10b to the voltage supply source 19 that generates a low AC voltage of a predetermined frequency and an amplitude of less than 500 volts.

If primary region 12 is applied with a to-be-determined resonance frequency of, for example, 500 KHz, mechanical vibrations of primary region 12 are induced due to the applied electrical AC voltage, which vibrations result in periodic changes in the thickness d of primary region 12 between electrodes 17a, 17b. These mechanical vibrations are also transmitted to secondary region 13.

Secondary region 13 is subdivided by the inventive approach into to partial regions 14 and 15 that have different—and specifically, opposite—polarization directions P. If secondary region 13 now also vibrates in resonance, the result is the formation of electrical fields or potential differences along the length 1 of secondary region 13 in the longitudinal direction L.

The greatest potential differences, and thus the greatest electrical field strengths, however, occur in connecting region 21 between the two partial regions 14 and 15, and specifically in particular in the free end region of secondary region 13. This is where a plasma 20 is formed, as indicated in FIG. 1 by a flat-shaped plasma cloud.

The apparatus described in FIG. 1 thus enables an end-face plasma to be generated with high efficiency.

Unit 11 provides a piezoelectric transformer (PT) and enables high-voltage potential differences to be generated along secondary region 13 from low-voltage source 19. As a result, an especially compact and simply-designed apparatus according to the invention can be realized.

With reference to FIG. 1, it should be noted that primary region 12 and secondary region 13 with the two partial regions 14 and 15 can be formed from a single workpiece that can be subdivided into three zones 16a, 16b, 16c with different polarization directions by applying corresponding polarization voltages and by configuring appropriate electrodes.

Alternatively, and not shown in FIG. 1, primary region 12 can be formed from a separate workpiece that is connected to secondary region 13. Finally, an approach is also possible by which the two partial regions 14 and 15 of secondary region 13 are provided by different workpieces that, not shown in FIG. 1, can be mechanically connected to each other. In sum, what must be stated is that unit 11 of FIG. 1 can be formed from one, two, or three different workpieces.

It should be noted here that primary region 12 can be composed of a plurality of workpieces. FIG. 1 shows a configuration in which two electrodes 12a and 12b are associated with primary region 12. The primary region can, however, also be subdivided into a plurality of partial regions, wherein a plurality of electrodes can be provided with alternating voltage. This type of layer design will be described below.

Based on FIG. 2, the functional principle of the apparatus 10 according to the invention will be described further. Here primary region 12 and secondary region 13 with the two partial regions 14 and 15 are in each case formed from separate elements. In the area of interfaces 22a, 22b, appropriate joining means are located, such as for example adhesives, which effect a sufficient mechanical bond, and in particular ensure the transmission of mechanical vibrations from primary region 12 to secondary region 13.

FIG. 2 clearly shows that primary region 12 can be polarized along different polarization directions P1, P2, or P3. Here polarization direction P1 of FIG. 2 corresponds to polarization direction P of FIG. 1, although the electrodes in the apparatus of FIG. 2 are not shown. Initially, the orientation of polarization direction P₁ is not important here. Alternatively, primary region 12 could, however, also be polarized along polarization direction P₂, where in this case flat electrodes must be disposed on the front side V shown in FIG. 2 and on the rear side not shown in FIG. 2, such that the connecting line of the electrodes corresponds to the polarization direction.

A polarization selected for polarization direction P₂ would analogously generate a mechanical resonant vibration of primary region 12, and accordingly produce a mechanical vibration is of secondary region 13 that ultimately generates the electrical fields indicated in FIG. 2 by E-arrows.

For the sake of clarity, the generated plasma on the top side F of unit 11 is not shown in FIG. 2.

For the sake of completeness, FIG. 2 finally shows another polarization direction P3 that runs essentially parallel to the polarization directions P of the secondary region. This is to show that by arranging electrodes, for example, in the area of the lower end of primary region 12 and in the area of the top end of primary region 12 it is theoretically possible to excite primary region 12 in the same way. Although in terms of design this type of configuration has disadvantages, it can nevertheless achieve the principle according to the invention.

With reference to FIGS. 1 and 2, it should be noted that in each case a primary region 12 or a yet-to-be-described primary partial region altogether must be set into resonant vibrations by applying electrical alternating fields. What is basically sufficient for this purpose are two spaced electrodes that between them can surround the piezoelectric material (primary region) of thickness (D). Alternatively, a plurality of parallel electrode plates can also be disposed along the thickness of width D of primary region 12, thereby creating a layer structure as will also be described below for other embodiments. In terms of construction, this layer structure is initially more complex, but can nevertheless have the advantage that the transfer rate of the excited low voltage relative to the high voltage to be achieved is improved. When more than two electrodes are disposed on a primary region that as a whole is to oscillate uniformly, what is required is a corresponding wiring of the electrodes or corresponding sequence of polarization directions for the segments of the primary region. This will be described in detail below.

FIG. 3 shows another embodiment of the apparatus according to the invention in a view comparable to FIG. 1. In this variant, the apparatus 10 according to the invention comprises a unit 11 that has two separate primary regions 12a and 12b, as well as two spatially separated partial regions 14 and 15 of opposite polarization. In the embodiment of FIG. 3, an insulating element 23 is located between the two partial regions 14 and 15 of secondary region 13. This can involve a mechanical and/or an electrical insulating element. The mechanical insulating element can at least partially decouple the two partial regions 14 and 15 from each other in terms of mechanical vibrations. Electrical insulating element 23 can ensure that the electrical fields do not generate any detrimental effects and that plasma 20 is generated solely in the area of the end face F of unit 11.

The two primary regions or primary partial regions 12a and 12b each have a separate pair of electrodes. FIG. 3 indicates, however, that the two primary regions 12a and 12b can also have a common electrode 17b.

The three electrodes 17a, 17b, 17c are connected to a low voltage source 19 and are excited in phase, and specifically, phase-coincidentally. Overall primary region 12 formed by the two primary regions 12a and 12b in the embodiment of FIG. 3 thus corresponds to primary region 12 of the apparatus 10 in FIG. 1 and vibrates overall synchronously.

FIG. 4 shows another embodiment of the apparatus 10 according to the invention in which the two primary regions 12a and 12b, and the two partial regions 14 and 15 of secondary region 13, are completely separated from each other by empty space 24. Empty space 24 provides a gas flow channel through that a suitable working gas or carrier gas can pass in the longitudinal direction L. FIG. 4 illustrates the formation of electrical fields E that can illustrate the potential differences and along which a plasma can form. FIG. 4 shows that the most greatest electrical field strengths occur in the area between the two end faces F1 and F2 of the two partial regions 14, 15.

FIG. 5 shows an the apparatus 10 that provides a row configuration of a plurality of partial regions 14a, 14b, 14c, and 15a, 15b, 15c, etc. Secondary region 13 is thus formed by a row configuration of, for example, parallepipedal partial regions 14a, 15a, 14b, 15b, 14c, 15c.

A plasma cloud 20a forms between each of the two partial regions of different polarization, e.g. between partial regions 14a and 15a. All of the partial regions denoted by 14 have a polarization along a first polarization direction, while all those partial regions denoted by 15 have a polarization in the opposite polarization direction.

Primary region 12 is subdivided into a plurality of individual primary regions. For example, partial region 14a has an associated primary region 12a that is subdivided into a primary partial region 12a1 and a second primary partial region 12a2 with opposite polarization. Primary region 12a has three electrodes 17a, 17b, and 17c that are connected through voltage supply lines to voltage supply 19. The two primary partial regions 12a1 and 12a2 are excited in phase, that is, phase-coincidentally, such that the entire primary region 12 resonates and can transmit its vibrations to corresponding partial region 14a. The other primary regions 12b as well as the primary regions shown but not identified in FIG. 5 all vibrate together synchronously, with the result that plasma cloud 20a, 20b, 20c is formed between each of the two adjacent partial regions of different polarization in the area of top side F.

In a bottom view indicated by directional-view arrow VI in FIG. 5, FIG. 6 illustrates the geometric structure of primary region 12 and shows that primary region 12 is composed of multiple elements extending longitudinally in direction S in the manner of a layer structure. One primary region each (e.g. 12a1) is composed of a disk-like element, and one electrode is located between each two primary regions, e.g. between primary regions 12a1 and 12a2. What is thus illustrated is that plasma clouds 20a, 20b, 20c can extend axially along top side F of the apparatus 10, similarly in direction S, thereby enabling a band-like pattern of plasma clouds to be formed there.

Finally, FIG. 7 illustrates that a plurality of partial regions 14a, 14b, 14c, 14d, 14e, 14f, 14g, 15a, 15b, 15c, 15d, 15e, 15f, of secondary region 13 can be disposed along one plane in the manner of a grid. Partial regions 14, 15 can thus also alternate in terms of their polarization direction along direction S. The view selected in FIG. 7 shows top side F of an the apparatus 10 in a top view. It is evident that a plurality of plasma clouds of cloverleaf-like form 20a, 20b, 20c, 20d are generated.

Each two adjacent partial regions, e.g. partial regions 14a, 15c, or partial regions 14a and 15a, have opposite polarization directions, as indicated by the symbols of the circled x and the circled dot. The polarization directions of adjacent partial regions thus alternate both in transverse direction Q as well as in the direction of arrow S.

FIG. 7 illustrates that a very large-area generation of plasma, thus large-area substrate treatment, becomes possible. A substrate to be treated can be moved along surface F, or the apparatus 10 can be moved relative to a stationary substrate.

Basically different geometries of embodiments of apparatuses according to the invention for generating a plasma will now be described based on FIGS. 8 through 15.

It should be noted here that in FIGS. 8 through 15 the electrodes that are disposed on the primary region or on the primary partial region are not shown for the sake of clarity.

FIG. 8 shows a unit 11 comprising a primary region 12 and a secondary region 13. Secondary region 13 is subdivided into a plurality of partial regions 14a, 14b, 14c, 14d, 14e, 15a, 15b, 15c, 15d that are composed of rod-shaped bodies of triangular cross-section. In each case in the area of the interfaces 22b between two differently polarized partial regions, e.g. between partial regions 14a and 15a, what results is the formation at the end face of a plasma cloud, not shown in FIG. 8.

In an alternative configuration of the apparatus 10 in FIG. 9, primary region 12 and secondary region 13 are each composed of a plurality of partial regions. Thus, primary region 12 is composed of primary partial regions 12a, 12b, 12c, 12d, 12e, while secondary region 13 is composed of corresponding secondary primary regions 13a, 13b, 13c, etc. where nine secondary partial regions and nine primary partial regions are shown but not all are identified.

Adjacent partial regions 14a, 14b, 14c, 15a, 15b, 15c are in turn oppositely polarized, thereby enabling intense electrical fields to be formed between each two partial regions 14a, 15a of different polarization. A gas flow channel 24 passes through between each two partial regions 14a, 15a, the channel running in the longitudinal direction L. The arrows G shown in FIG. 9 illustrate the gas flow.

All primary partial regions 12a, 12b, 12c, 12d, 12e, etc. are excited in a fixed phase relationship to each other, that is, in particular phase-coincidentally, thereby allowing the generation of the electrical fields between partial regions 14a, 14b, 14c, and 15a, 15b, 15c to be controlled.

FIG. 9 illustrates that a gas flow passing through between two partial regions 15a, 14b of opposite polarization can be carried through by a plasma that can be generated not only exclusively in the area of the end faces of partial regions 15a, 14b, but also in the area of flow channel 24. This provides an is improved interaction of the gas flow with the plasma.

FIG. 10 shows another alternative embodiment of an the apparatus 10 according to the invention in a view based on FIG. 8 that comes relatively close to the geometric structure shown there. Here partial regions 14a, 15a of secondary region 13 are composed of cylindrical bodies of square cross-section. Each two adjacent partial elements of the secondary region, e.g. partial regions 14a and 15a, or partial regions 15a and 14b, have opposite polarization directions, with the result that plasma clouds, not shown, are formed in the area of interfaces 22b between each two partial regions with different polarization directions.

FIG. 11 shows another embodiment of the apparatus 10 according to the invention in which two separate units are provided that each have a primary region 12 and a secondary region 13. The first unit is designed in the form of a rod-shaped body and accordingly has a primary partial region 12a of square cross-section that merges into a partial region 14 of the same cross-section. A second unit is designed in the manner of a cylindrical tube of square cross-section in the manner of a cylindrical tube of square cross-section and surrounds the first unit concentrically. The second radially polarized primary partial region 12b associated with the second unit merges into partial region 15 of secondary region 13 that has the same geometric structure as second primary partial region 12b.

An annular fee space 24 is located between the two primary partial regions 12a and 12b, and between the two partial regions 14 and 15, which empty space forms a gas flow channel. A plasma can form within gas flow channel 24 between the two partial regions 14 and 15.

When primary region 12 is excited with the two primary partial regions 12a and 12b in phase, that is synchronously, the two partial regions 14 and 15 are oppositely polarized, thereby enabling a plasma to form in the area of gas flow channel 24 along the outer surface of partial region 14, or along the inner surface of partial region 15.

FIG. 12 shows another variant of the apparatus 10 according to the invention in which primary region 12 and secondary region 13 are composed of rings that are concentrically un-spaced radially from each other. Centrally disposed is an essentially rod-shaped body of square cross-section that has a primary region 12a and merges into secondary partial region 14a. Primary region 12a is concentrically surrounded by a second primary partial region 12b that merges into partial region 15a of the secondary region, where partial region 15b has a polarization direction opposite to partial region 14a.

Finally, a third primary partial region 12c is provided that concentrically surrounds the two primary partial regions 12a and 12b. Third partial region 14b of secondary region 13 has the same polarization direction as partial region 14a.

Essentially annular plasma clouds can form at the back, with reference to FIG. 12, end face F along the connecting regions of partial regions 14a, 15b, and 14b.

If, as shown in FIG. 12, three concentric annular primary partial regions 12a, 12b, 12c are provided, a tubular electrode can is be provided between annular regions 12c and 12b along connecting line 22b. An insulator can be provided between primary partial regions 12b and 12a along associated connecting line 22b, which insulator surrounds rod-shaped primary partial body 12a in a jacket-like manner. The inside of the insulating element has, for example, two plate-like electrodes that face each other and account for the shown primary polarization direction PP. On the side of this insulating element facing annular body 12b, again another tubular electrode could then be disposed that is associated with annular region 12e.

Alternatively, in a geometric structure based on FIG. 12 it is conceivable that the area of primary region 12 denoted by 12b is composed of an insulating gap. Then primary region 12 would only have two primary partial regions 12a and 12c that would be separated by one insulator.

Finally, the primary partial region denoted by 12b could also be eliminated and form an annular gas flow channel.

FIG. 13 shows another variant of the apparatus 10 according to the invention in a view similar to FIG. 11, where in contrast to FIG. 11 the essential difference consists in the fact that primary partial region 12a is not composed of an essentially rod-shaped body of square cross-section, but of a hollow annular body that provides an opening 25 at its center that can similarly form the gas flow channel. An examination of this FIG. makes evident that secondary region 13 has a geometric structure corresponding to primary region 12.

FIG. 14 shows another embodiment of the apparatus according to the invention in which primary region 12 and secondary region 13 are composed of separate partial regions. Primary partial region 12a has the shape of a parallepipedal of rectangular cross-section and merges into a corresponding partial region 14 of secondary region 13. Primary partial region 12b has an identical cross-section and merges into a partial region 15 of secondary region 13. Empty space 24 is located between primary partial regions 12a and 12b, which space is designed as a gas flow channel. The gas flow occurs in the direction of the indicated arrows G. Partial regions 14 and 15 are oppositely polarized in the longitudinal direction L.

FIG. 15 shows another variant of the apparatus according to the invention in a view similar to FIG. 14, wherein in contrast to FIG. 14 an insulating element 23 is provided between the two parallepipedal elements. This embodiment is relatively similar to the embodiment of FIG. 3.

It should be noted that in FIG. 15 electrodes are also not shown. In place of an insulating gap, electrodes could also be provided between the two primary partial regions 12a and 12b. Corresponding counter-electrodes could then be disposed on the outer surfaces of primary partial regions 12a and 12b.

It should be noted that a geometric configuration in the manner of a combination of the embodiments of FIGS. 3 and 15 is also possible in which in insulating gap 23 is provided between the two primary partial regions 12a and 12b, where one electrode each is disposed on the two outside faces of insulating gap 23.

The critical factor for the above-described embodiments is that the primary partial regions are excited synchronously, that is, in resonance.

Another embodiment of the apparatus 10 according to the invention is described below based on FIG. 16:

The apparatus 10 again comprises a primary region 12 that can be excited to resonate by means of low AC voltage and a secondary region 13 excitable thereby to generate high voltage. Secondary region 13 is subdivided into two partial regions 14 and 15 that are polarized in the same polarization direction P, and between which a insulating element 23 is located. Each partial region 14, 15 is vibrationally connected to an associated primary partial region 12a, 12b, meaning that resonant vibrations can be transmitted between a primary partial region 12a, 12b and the associated partial region 14, 15 of secondary region 12. First primary partial region 12a has an electrode 17a and an opposing electrode 17b. Second primary partial region 12b has an electrode 17c and electrode 17b already mentioned above. Both primary partial regions 12a and 12b are polarized along the same polarization direction P. Based on the wiring of the electrodes shown in FIG. 16, at each instant the same potential is applied to electrodes 17a or 17c. As a result, the two primary partial regions 12a and 12b are excited 180° phase-displaced. The configuration of the two primary partial regions 12a and 12b is thus implemented in a push-pull fashion.

Due to the described 180°-phase-displaced or phase-shifted excitation of the two primary partial regions 12 and 12b, partial regions 14 and 15 of secondary region 13 start to vibrate, whereby partial regions 14, 15 similarly vibrate in a phase-displaced manner. As a result, the maximum potential differences along connecting line 21 are formed between the two partial regions 14 and 15, with the result that a plasma 20 is formed at end face F of the apparatus 10.

Insulating element 23 functions to mechanically and electrically decouple the two partial regions 14 and 15 from each other. This increases the efficiency of the described apparatus.

As was described above in regard to other embodiments, a partial region 14, 15 and an associated primary partial region 12a, 12b can be formed from a unitary workpiece by different polarization, or fabricated from separate, mutually attached workpieces. Alternatively to the configuration created based on FIG. 6, opposite polarization directions can also be provided for the two primary partial regions 12a and 12b, whereby phase-coincident excitation is then effected.

FIG. 17 is a schematic view showing the functional principle of the apparatus of FIG. 16, where rather than providing an insulating element 23, an empty space 24 is retained between the two secondary partial regions 14 and 15 instead. This empty space can provide a gas flow channel.

For the sake of clarity, the electrodes to be disposed on primary partial region 12a or 12b are not shown. The generated plasma is also omitted for the sake of clarity.

FIG. 17 illustrates that is irrelevant along which of the three polarization directions Pa, P2, or P3 an excitation of the primary partial region occurs. The critical point is that what results is a synchronous, 180° phase-shifted excitation of the two primary partial regions 12a and 12b.

The push-pull excitation results in the formation of electrical fields that are indicated schematically in FIG. 17 by the field lines E shown. The synchronous excitation of the two primary partial regions 12a and 12b enables the field located in empty space 24 to be amplified in an optimal manner.

Another group of embodiments of the apparatus according to the invention are described below based on FIGS. 18 through 26.

FIG. 18 shows an essentially parallepipedal the apparatus 10 according to the invention that has a primary partial region 12 and a secondary region 13. In primary partial region 12, the polarization direction is denoted by PP, while in secondary region 13 the polarization direction is denoted by PS. FIG. 18 illustrates that the primary region is polarized in the radial direction and the secondary region is polarized in the longitudinal direction L.

The apparatus 10 has running through it a central passage opening 24 that extends along the entire axial length A=I+a of the apparatus 10. Passage opening 24 can provide the gas flow channel, where the gas is able to flow through the apparatus in the direction of the arrow G.

When primary region 12 is excited to resonate by electrodes, not shown in FIG. 18, the result is the formation of electrical fields in the area of passage opening 24 along the inner surface IF of secondary region 13 due to electrical potential differences along the longitudinal direction L. As a result, a plasma can form within the passage channel 24. The electrodes required to excite the primary region are located on the inside and outside of primary region 12.

FIG. 19 shows a configuration similar to FIG. 18 in which passage channel 24 has a circular cross-section, and wherein unit 11, which provides primary partial region 12 and secondary region 13, is composed of cylindrical, essentially tubular body.

Similarly in the embodiment of FIG. 18, primary region 12 is polarized in radial direction PP, wherein an electrode located on the inner peripheral surface IF of primary region 12 and an opposing electrode located on the outer peripheral surface AF of primary partial region 12, not shown in FIG. 19, is provided to operate the apparatus 10.

FIG. 20 illustrates another embodiment of the apparatus 10 according to the invention in which unit 11 is designed a parallepipedal of square cross-section that in turn is subdivided into a primary partial region 12 and a secondary region 13. Unit 11 has passage channels of square cross-section passing through it longitudinally. In primary region 12, each of passage channels 24a, 24b, 24c, etc. has an electrode, not shown. The electrode thus forms each wall of gas channel 24 in primary region 12. Primary region 12 is polarized as indicated by illustrated polarization arrows PP. Secondary region 13 is polarized uniformly along polarization direction PS.

Atmospheric plasmas are formed along the longitudinal direction L in secondary region 13 within passage channels 24a, 24b, 24c, etc.

In a view based on FIG. 1, FIG. 21 shows an apparatus of FIG. 19. In this embodiment of the apparatus 10 according to the invention, unit 11 is composed of a tubular circular-cylindrical body, whose primary region 12 is polarized radially, and whose secondary region 13 is polarized opposite to the longitudinal direction L. FIG. 21a shows that the two electrodes 17a and 17b are essentially designed in the manner of a tube kept axially extremely short. Electrodes 17a and 17b shown in FIGS. 21 and 21a are illustrated in an exaggeratedly large view. It is evident to the viewer that the electrodes are in fact of quite thin design—for example, only a few μms thick. This also applies to all other embodiments illustrated in this patent application.

Inner electrode 17b of primary region 12, and inner peripheral surface IF of secondary region 13 provide the wall of gas flow channel 24. The gas flow is indicated by arrow G.

Atmospheric-pressure plasma 20 is formed along gas channel 24 in secondary region 13, which plasma extends in the form of a plasma jet 26 out of orifice M of secondary region 13. The substrate to be treated, which the viewer of FIG. 21 must imagine roughly above the top side F of the apparatus 10, can be covered and treated by plasma jet 26. The length of plasma jet 26 in the longitudinal direction L depends, inter alia, on the flow velocity of the gas.

FIG. 22 illustrates that a plurality of plasma jets 26a, 26b, 26c are generatable if multiple tubular units 11 are disposed in a row, as FIG. 23 shows more clearly, along a plane in the manner of a grid. In a row configuration indicated by FIG. 22 that extends in transverse direction Q, a longitudinally extended plasma band can be generated if plasma jets 26a, 26b, 26c overlap or approach each other. In the case in which units 11a, 11b, 11c in the apparatus 10 of FIG. 23 extend along a plane to form a grid, it is possible to generated a laminar plasma, or in at least any desired number of adjacently-disposed plasma jets.

Operation of a multijet apparatus as indicated in FIG. 22 or FIG. 23 is effected by operating individual primary partial regions 12a, 12b, 12c in phase, i.e. phase-coincidentally. Each inner electrode of a unit 11a simultaneously provides an outer electrode of an adjacent unit 11b. Inner electrode 17a of unit 11a, for example, thus simultaneously provides outer electrode 17a of unit 11b. Partial regions 14a, 14b, 14c 14d of secondary region 13 are all polarized along the same polarization direction P. Each two adjacent primary partial regions 12a, 12b, 12c of the apparatus 10 are disposed in a push-pull fashion, i.e. they are operated 180° phase-displaced. It should be noted here, however, that, for example, the wall between gas flow channels 24a and 24b is formed in common by primary partial regions 12a and 12b. A first primary partial region 21a is associated with gas flow channel 24a, while a second primary partial region 12b is associated with gas flow channel 24b. While at a given vibration instant, for example, a primary partial region 12a has just effected a radially inward-directed maximum movement by which gas flow channel 24a is constricted (if only imperceptibly), adjacent gas flow channel 24b is at the same instant (imperceptibly) radially maximally expanded. As a result, the two primary partial regions 12a, 12b are exactly 180° phase-displaced. In this way, electrical fields are formed in gas flow channels 24a, 24b, 24c of the three units 11a, 11b, 11c along secondary region 13.

In a row configuration, the cross-section of gas flow channels 24a, 24b is arbitrary, and can be formed, for example, by a circular or rectangular cross-section, or alternatively by any other desired cross-section.

FIG. 23 shows the apparatus of FIG. 22 scaled up to a grid in a bottom view indicated by directional-view arrow XXIII in FIG. 22. It is evident that each electrode is surrounded by four adjacent electrodes. For example, electrode 17a is thus surrounded by four electrodes 17e, 17b, 17d, and 17f.

FIG. 23 shows that electrode 17a surrounds gas flow channel 24 of square cross-section. It is evident to the viewer that other cross-sectional shapes are possible.

FIG. 23a shows the apparatus scaled up to a grid as indicated in a top view in FIG. 22, that is, as indicated by directional-view arrow XXIIIa in FIG. 22. The top illustrate that a plurality of plasma jets 20a, 20b, 20c disposed in a grid-like fashion can be generated. The x symbols in the circles illustrate that the entire honeycomb structure of secondary region 13 is polarized along the same polarization direction, i.e. in the longitudinal direction L.

FIG. 24 show another embodiment of the apparatus 10 according to the invention in which unit 11 is provided with a primary region 12 and a secondary region 13. The apparatus is corresponds closely to the apparatus shown in FIG. 19; for this reason, reference is made to a plurality of details so as to avoid repetitions. The special feature here is a gas flow channel 24 that has an essentially rectangular cross-section. The polarization directions of the primary region 12 are denoted in FIG. 24 by PP, while those of secondary region 13 are denoted by PS. FIG. 24 shows that primary region 12 can be polarized approximately radially.

FIG. 25 shows another embodiment of the apparatus according to the invention in a view comparable with FIG. 21. In contrast to the apparatus of FIG. 21, the apparatus 10 of FIG. 25 is provided with an orifice nozzle 27, by which the formation of a plasma jet 28 can be advantageously modified. Otherwise in terms of its structure, the apparatus matches the apparatus of FIG. 21; for this reason, reference is made to the above embodiments so as to avoid repetitions.

FIG. 26 shows another embodiment of the apparatus according to the invention in a view based on FIG. 25, wherein the region of orifice M of the apparatus 10 is slightly modified. Here the corner regions E shown in FIG. 25 are eliminated so as to produce a pincer-like configuration.

The physical principle of plasma generation according to the invention will now be explained once again based on FIGS. 27 and 28.

FIG. 27 is a part-sectional schematic view of section through a tubular body that has a square cross-section. The view of FIG. 27 corresponds approximately to a longitudinal section through the apparatus of FIG. 18 along a center plane, wherein gas flow channel 24, in contrast to the view of it in FIG. 18, has in the view of FIG. 27 an essentially square cross-section.

The illustrated tubular body forms unit 11 as a component of the apparatus 10 for generating an atmospheric-pressure plasma. Unit 11 consists of a piezoelectric material and is subdivided into primary region 12 and secondary region 13. Primary region 12 is excited along any one of the three polarization directions P1, P2, P3. Preferably, a radial polarization direction P1 will be selected so as to be able to attach a sleeve-like or tubular inner electrode to inner peripheral surface IF of primary region 12 and a corresponding outer electrode to outer peripheral surface AF of primary region 12. In the case of other electrode geometries not shown, an approach could also certainly be considered wherein primary region 12 is excited along-polarization direction P2 or P3.

In the last analysis, the selected polarization direction of primary region 12 is not important. The specifically selected polarization direction, i.e. polarization direction P1, P2, or P3, only results in a correspondingly determined configuration for the electrodes, not shown. What is true is that primary region 12 is excited to resonate as a whole and can transmit its vibrations to secondary region 13 with a predetermined, longitudinally running polarization.

A resonant excitation of primary region 12 results in the transmittance of vibration at resonance frequency to secondary region 13 such that an electrical field propagates along the longitudinal direction L. Gas channel 24 can have gas flowing through it from bottom to top, whereby a plasma is formed in the area of the most intense electrical fields. The fact that gas channel 24 is surrounded at the opposing sides of the material regions of the vibrating secondary region 13 enables a very advantageous field geometry to be achieved that promotes the plasma generation.

In an alternative embodiment of the invention based on FIG. 28, secondary region 13 is polarized differently. FIG. 28 again illustrates a schematic part-sectional view of an essentially tubular element. The left, with reference to FIG. 28, partial region of secondary region 13 is polarized in polarization direction Pₐ, while the right, with reference to FIG. 28, partial region 15 of secondary region 13 is polarized in polarization direction Pᵤ.

Since in the embodiment of FIG. 28 as well, the entire secondary region 13 can be composed of a single workpiece, an explanation must be provided as to how the polarization directions behave in the transition region between partial regions 14 and 15. It must be noted in this regard that the desired polarization can be obtained, for example, by disposing a second electrode of opposite polarity in the area of B2 during polarization. The polarization in the longitudinal direction L is then at maximum after effected polarization in area B1, and at maximum with the opposite polarization direction in area B2. In an area B3, polarization diminishes and attains approximately a zero value in an area B4, or reverses its sign. It is thus evident that the greatest potential difference—and thus, as shown in FIG. 28, the most intense electrical fields—occur in the range between areas B1 and B2.

Whereas the apparatus of FIG. 27 functions primarily to generate a plasma in the interior of gas flow channel 24, the apparatus of FIG. 28 can be employed especially advantageously to generate a plasma in the area of orifice M of gas channel 24.

In a view based on FIGS. 27 through 28, a specially structured electrode 17c is disposed on inner surface IF of primary region 12. As is clearly evident, electrode 17c has a plurality of tines 28a, 28b, 28c, on the region facing secondary region 13. The tines can promote fast triggering of the plasma since the electrical fields are formed here appropriately. Especially intense field strengths are typically achievable in the area of the edges of the electrodes, thereby enabling plasmas to be triggered faster and earlier.

FIG. 30 shows another embodiment of the apparatus 10 according to the invention in which one of the various previous configurations, for example, a configuration indicated by FIG. 22, is disposed within a housing 29. The housing has a gas inlet 30 that is connected to a gas supply, not shown. Pressure Pᵢ is present in housing 29 and is greater than P₀ that corresponds to atmospheric pressure. The pressure differential ensures the specified flow of gas that is illustrated by the indicated arrows G.

The apparatus 10 of FIG. 30 has a plurality of units 11a, 11b, 11c that are disposed analogously to the apparatus of FIG. 21 in row or along a plane in the manner of a grid. By way of example, four units here 11a, 11b, 11c, lid are shown, each having a separate gas flow channel 24a, 24b, 24c, 24d. Each unit has a front primary region 12a, 12b, 12c, 12d in the gas flow direction, and a rear secondary region 13 in the gas flow direction. Plasma jets are formed in the orifice regions Ma, Mb, Mc, and Md.

The apparatus of FIG. 30, in particular, also enables parasitic discharges at the lateral boundaries to be prevented.

FIG. 31 shows another embodiment of the apparatus 10 according to the invention in which a layer structure 31 of obliquely inclined layers is provided. FIG. 31 shows a first layer 31a, a second layer 31b, a third layer 31c, and a fourth layer 31d. Each of the layers consists of piezoelectric material and provides a primary region 12 and an associated secondary region 13. Secondary regions 13 are each polarized in the longitudinal direction L, or opposite to the longitudinal direction L. Each two mutually adjacent layers have partial regions 14a, 14b, 15a, 15b of secondary region 13 that are oppositely polarized.

Primary regions 12a, 12b, 12c, 12d of individual layers 31a, 31b, 31c, 31d are polarized transversely to the polarization direction of secondary region 13. Each primary region 12 comprises a pair of electrodes 17a, 17b; 17, 17c, where each two mutually adjacent primary regions 12a, 12b share a common electrode (e.g. 17b).

What is important is that all primary regions 12a, 12b, 12c, 12d are excited in constant phase, but without phase shift, phase-coincidentally. This enables in particular intense electrical fields to be formed in each of the connecting regions of two adjacent partial regions (14a, 15a) along the connecting regions of top side F of the apparatus. This enables plasmas 20, 20a, 20b, 20c shown in FIG. 31 to be generated.

As was explained above, the high voltages or field strengths to be achieved are dependent on the axial length 1 of secondary region 13. Large axial lengths are thus desirable. The obliquely oriented layer structure 31 of FIG. 31 enables a low overall height BH for the apparatus 10 to be achieved, thereby providing a compact design.

FIG. 32 shows another embodiment of the apparatus according to the invention in a view comparable with FIG. 6. FIG. 32 illustrates that between each two primary partial regions 12a, 12b, that have essentially disk-like or plate-like structures, in each case empty space 24 can also be retained that can provide the gas flow slit. A corresponding-plasma band can emerge through gas flow slit 24 on the top side opposite the bottom side shown in FIG. 32. It is also self-evident that plasma generation is also possible within gas flow slit 24.

Finally, FIG. 33 shows another embodiment of the apparatus 10 according to the invention, in which the unit 11 is composed of a corrugated element. FIG. 33 illustrates that the surfaces of unit 11 are curved. Compared to a planar surface, a curved surface provides an improved interaction between the gas flowing past the surfaces and the plasma generated along the surfaces. A curved surface of primary region 13 provides a curved inner surface IF that encircles, at least partially, gas flow channel 24. The gas flow is indicated in FIG. 33 by arrow G.

It is evident that several of the corrugated-like structures of FIG. 33 can also be disposed parallel to each other. FIG. 33a diagrams such a configuration. This illustrates that a plurality of practically completely enclosed gas flow channels 24a, 24b results when a correspondingly offset arrangement of two corrugated structured units 11a and 11b is selected. FIG. 33a corresponds to a schematic cross-sectional view indicated by directional-view arrow XXXIIIa in FIG. 33.

FIG. 33b shows a parallel, non-offset arrangement of two corrugated units 11a and 11b. What results here is a wave-like continuous gas flow slit 24.

It is also possible to dispose a plurality of comparable corrugated-like structures 11a and 11b in a stacked configuration.

The plurality of embodiments shown and described illustrates that the critical aspect for the invention is that a piezoelectric transformer be equipped with a specially designed primary region and a specially designed secondary region. Some embodiments also provide parallel configurations of multiple piezoelectric transformers. For the case in which continuous openings are provided in the secondary region, and advantageously in similar fashion as well in the primary region, as is shown, for example, in FIG. 21, it is recommended that the primary region be polarized in the radial direction.

With some of the above-described embodiments—e.g. in the embodiment of FIG. 2—the polarization direction of the primary region is not important. In the event multiple primary regions are provided, as for example in the embodiment of FIG. 3, the polarization directions of the primary regions are similarly not critical in some of the above-described embodiments. The only essentially aspect given multiple primary regions or primary partial regions is that a synchronous excitation be effected, i.e. that the primary regions of different units 11a, 11b or 11c, or the partial regions of unit 11, vibrate in phase, that is, either phase-coincidentally, i.e. without phase shift, or 180° phase-displaced. To this end, the different primary regions of the different primary partial regions can be connected to a common voltage supply 19 through separate voltage supply lines 19a and 19b.

From the above explanations it is also evident that the polarization directions of secondary region 13, or of the associated partial regions, are ultimately also not a stringent requirement. For example, the embodiment of FIG. 15 can be operated with the polarization directions shown for secondary region 13, according to which the two partial regions 14 and 15 are oppositely polarized. Similarly, however, another approach to be considered is to equip the two partial regions 14 and 15 with a unidirectional polarization direction, and to excite the associated primary partial regions 12a and 12b in a push-pull manner. Finally, the embodiment of FIG. 15 can, however, also be operated with a synchronous configuration of primary partial regions 12a and 12b.

The same considerations in regard to the selection of polarization directions also apply to the other embodiments, whereby the polarization directions and geometries of units 11, 11a, 11b, and 11c are selected primarily as a function of whether an atmospheric-pressure plasma within a gas flow channel, a plasma jet, or an end-face plasma is to be generated.

Based on a comparison of FIGS. 1 and 3, it furthermore becomes evident that is not important whether primary region 12 is or is not subdivided into multiple primary partial regions 12a, 12b. While primary region 12 of FIG. 1 resonates as a whole since an alternating field is generated between the two electrodes 17a and 17b, primary region 12 of the embodiment of FIG. 3, composed of two primary partial regions 12a and 12b, similarly vibrates as a whole since here electrodes 17a, 17b, 17c disposed correspondingly in oppositely poled fashion are provided.

The number of electrodes for achieving the same purpose can also be increased as desired, where the material thickness remaining between two electrodes and the voltage applied to the electrodes is a measure of the voltage transfer ratio from the primary region to the secondary region.

Finally, in the various embodiments of the apparatus 10 according to the invention any desirable geometry of primary region 12 and secondary region 13 can selected and adapted to the specified purpose of the application. For example, units 11a and 11b of FIG. 14 can, for example, extend in transverse direction Q, thereby forming plate-like extended bodies. A plurality of additional units can then still be linked in direction S to the two units shown, 11a and 11b, with the result that a layer structure, as shown in FIG. 32, is able to be achieved.

It should be furthermore noted that a honeycomb structure of a row configuration 11, as shown in FIG. 23a, can be fabricated especially easily by pressing through or discharging piezoelectric material in an extrusion process through a complementary counter-honeycomb-structure, while passage channels 24 are generated by corresponding mandrels in the extruder nozzle, or by a corresponding counter-honeycomb-structure of the nozzle.

Polarization of this type of honeycomb workpiece can be effected by immersing the workpiece with its first end region intended to form the secondary region into a metallic liquid or the like, thereby attaching electrodes along the walls of the gas flow channels. After attachment of the electrode, the workpiece can be mounted, for example, on a circuit board or the like, on which a plurality of parallel spring terminals or spring contacts are disposed. Due to a convergence of the honeycomb structure with the board, the spring terminal contacts can at the same time be introduced into the corresponding gas flow channels, thereby contacting the electrodes previously attached there. A polarization of the primary region to achieve polarization as in FIG. 23 can be implemented subsequently, for example, in an oil liquid or oil bath that increases the dielectric strength, whereby each two adjacent electrodes have the polarization voltage, differently poled, applied to them.

The secondary region of this honeycomb structure can then be polarized by applying a counterelectrode to the top side, i.e. to the honeycomb structure remote from the primary region, then inserting a polarization voltage between this counterelectrode and the above-mentioned spring terminal contacts. This enables the polarization of secondary region 13 shown in FIG. 23a to be achieved.

Alternatively, it is also possible to polarize the honeycomb structure of FIG. 23a such that each two adjacent partial regions, e.g. partial regions 14a and 14b, are not polarized along the same polarization direction but along opposite polarization directions. This is enabled by moving a corresponding counterelectrode, provided with appropriate electrodes, to the top side of the honeycomb structure to effect a polarization of the secondary region.

It should be noted in reference to FIG. 33 that in addition to endlessly continuing corrugated structures it is also possible to provide units 11 that have only one segment of such a corrugated structure. What is conceivable, for example, are segment-like sections that have been specially curved, and, e.g. run only between points X and Y of FIG. 33a. This involve sections kept relatively short in transverse direction Q, which sections can, however, be combined to form any desired structures and due to the curved surface provide an improved interaction between the plasma and working gas, or make possible an improved generation of plasma.

A scaling up to apparatuses of any desired size is possible with the numerous above-described apparatuses according to the invention. Correspondingly large-dimensioned apparatuses could be used to generate large-area or large-volume plasmas.

Similarly, the apparatuses according to the invention make possible a compact design in the direction of miniaturized designs. Such miniaturizations are not possible with conventional apparatuses for plasma generation that require separate high voltage generators and corresponding special high-voltage lines with special insulation clearances.

With the apparatuses according to the invention, it is possible to treat, or optionally generate, microstructures as well. For example, gas flow channels 24 can be designed with almost any desired small diameters, and specifically using honeycomb structures as indicated, for example, in FIG. 23a.

1. An apparatus for generating an atmospheric-pressure plasma, in particular, for treating a substrate, comprising a unit composed of piezoelectric material, including at least one partial region on which at least two electrodes are provided to apply a low AC voltage, and including a secondary region, in a longitudinal direction whose potential differences are created due to the excitation of the primary region wherein the secondary region comprises two partial regions that are oppositely polarized in the longitudinal direction.

2. The apparatus according to claim 1 wherein the two partial regions are oriented essentially parallel relative to each other.

3. The apparatus according to claim 1 wherein an excitation of the primary region generates a potential difference in a direction transverse to the longitudinal direction between the two partial regions.

4. The apparatus according to claim 1 wherein the two partial regions are oriented adjacent each other.

5. The apparatus according to claim 1 wherein the two partial regions are provided immediately against each other.

6. The apparatus according to claim 5 wherein the two partial regions are composed of a common workpiece that is polarized in opposite directions.

7. The apparatus according to claim 5 wherein the primary region and the secondary region are composed of a common workpiece that is polarized in at least three different directions.

8. The apparatus according to claim 1 wherein the primary region and the secondary region, and/or the partial regions are composed of different workpieces that are attached to each other.

9. The apparatus according to claim 1 wherein the two partial regions are spaced slightly apart from each other.

10. The apparatus according to claim 1 wherein a separate primary region is associated with each partial region.

11. The apparatus according to claim 10 wherein the two primary regions are provided in a synchronized fashion, and in particular are excitable without phase shift.

12. The apparatus according to claim 10 wherein each of the two primary regions has a separate pair of electrodes.

13. The apparatus according to claim 12 wherein at least one common electrode is associated with the two primary regions.

14. The apparatus according to claim 1 wherein an empty space is provided between the two partial regions.

15. The apparatus according to claim 1 wherein a gas channel is provided between the two partial regions.

16. The apparatus according to claim 1 wherein an insulator is provided between the two partial regions.

17. The apparatus according to claim 1 wherein a plurality of partial regions is oriented linearly in row, in particular, transverse to the longitudinal direction.

18. The apparatus according to claim 17 wherein the polarization directions of the partial regions alternate along the row.

19. The apparatus according to claim 1 wherein a plurality of partial regions are oriented in a plane in the manner of a grid.

20. The apparatus according to claim 19 wherein the polarization directions of the partial regions alternate along a first direction transverse to the longitudinal direction, and along a second direction perpendicular to the first direction and perpendicular to the longitudinal direction.

21. An apparatus for generating an atmospheric-pressure plasma, in particular for treating a substrate, comprising a unit composed of piezoelectric material, including at least one primary region on which at least two electrodes are provided to apply a low AC voltage, and including a secondary region, in the longitudinal direction where potential differences form due to an excitation of the primary region wherein the secondary region is composed of two separate partial regions that are polarized along the same polarization direction, that a separate primary region is associated with each partial region, and that the two primary regions are provided in a push-pull fashion.

22. The apparatus according to claim 21, wherein the two primary regions have a coincident polarization direction and are excitable 180° phase-displaced.

23. The apparatus according to claim 21 wherein the two primary regions have opposite polarization directions and are excitable in a phase-coincident manner, i.e. in phase and without phase shift.

24. The apparatus according to claim 21 wherein each of the two primary regions has a pair of electrodes.

25. The apparatus according to claim 24 wherein the two primary regions have at least one common electrode.

26. The apparatus according to claim 21 wherein the two partial regions are oriented essentially parallel to each other.

27. The apparatus according to claim 21 wherein the two partial regions are oriented adjacent each other.

28. The apparatus according to claim 21 wherein one primary region each and one partial region are formed from a common workpiece.

29. The apparatus according to claim 27, wherein the two partial regions are slightly spaced apart relative to each other.

30. The apparatus according to claim 29 wherein an empty space is provided between the two partial regions.

31. The apparatus according to claim 30 wherein a gas channel is provided between the two partial regions.

32. The apparatus according to claim 27, wherein an insulator is provided between the two partial regions.

33. The apparatus according to claim 21 wherein a plurality of partial regions is oriented linearly in row, in particular transverse to the longitudinal direction.

34. The apparatus according to claim 33, wherein the push-pull operation of the associated primary regions alternates along the row of partial regions.

35. The apparatus according to claim 21 wherein a plurality of partial regions are oriented in a plane in the fashion of a grid.

36. The apparatus according to claim 35 wherein the push-pull operation of the associated primary regions alternates along a first direction transverse to the longitudinal direction, and along a second direction perpendicular to the first direction and perpendicular to the longitudinal direction.

37. An apparatus for generating an atmospheric-pressure plasma, in particular for treating a substrate, comprising a unit composed of piezoelectric material, including at least one partial region on which at least two electrodes are provided to apply a low AC voltage, and including a secondary region extending in longitudinal direction, wherein potential differences are created along a longitudinal direction due to the excitation of the primary region wherein a second unit is provided including a second separate primary region and including a second separate secondary region extending longitudinally, that the two secondary regions are aligned parallel to each other and oriented spaced apart from each transverse to the longitudinal direction, and that the two secondary regions form between themselves a gas flow channel running in the longitudinal direction.

38. The apparatus according to claim 37 wherein a plurality of secondary regions is oriented in a straight row, and that a plurality of gas flow channels running in the longitudinal direction is formed.

39. The apparatus according to claim 37 wherein a plurality of secondary regions are oriented in a plane, in particular in the manner of a grid, and a plurality of gas-carrying channels is formed running in the longitudinal direction.

40. An apparatus for generating an atmospheric-pressure plasma, in particular, for treating a substrate, comprising a unit composed of piezoelectric material, including at least one primary region on which at least two electrodes are provided to apply a low AC voltage, and including a secondary region, in the longitudinal direction where potential differences are created due to the excitation of the primary region wherein the secondary region has a curved inner surface that forms a wall of a gas-carrying channel.

41. The apparatus according to claim 40 wherein the curved inner surface represents a boundary surface for the atmospheric-pressure plasma.

42. An apparatus for generating an atmospheric-pressure plasma, in particular, for treating a substrate, comprising a unit composed of piezoelectric material, including at least one primary region on which at least two electrodes are provided to apply a low AC voltage, and including a secondary region, in the longitudinal direction where potential differences are created due to the excitation of the primary region wherein a continuous gas flow channel running in the longitudinal direction is provided in the secondary region, and that the secondary region completely encircles the gas flow channel.

43. The apparatus according to claim 42 wherein the secondary region with its inner surface provides a wall of the gas flow channel.

44. The apparatus according to claim 42 wherein the gas flow channel passes through the primary region.

45. The apparatus according to claim 42 wherein the unit is of essentially tubular form.

46. An apparatus for generating an atmospheric-pressure plasma, in particular, for treating a substrate, comprising a unit composed of piezoelectric material, including at least one primary region on which at least two electrodes are provided to apply a low AC voltage, and including a secondary region, in the longitudinal direction where potential differences are created due to the excitation of the primary region wherein in the secondary region multiple continuous, parallel gas flow channels are oriented running in the longitudinal direction.

47. A workpiece composed of piezoelectric material, including at least one primary region on which at least two electrodes are provided to apply a low AC voltage, and including a secondary region, in the longitudinal direction where potential differences are created due to the excitation of the primary region wherein the workpiece has at least three zones of different polarization.

48. A method of polarizing a unitary workpiece composed of piezoelectric material the method comprising the steps of sequentially
a) polarizing a first zone of the workpiece along a first direction to obtain one primary region,
b) subsequently, polarizing a second zone of the workpiece along a second direction to obtain a first partial region of a secondary region, and
c) polarizing a third zone along a third direction to obtain a second partial region of the secondary region, the third direction being opposite the second direction.

49. The method according to claim 48 wherein the steps b)]] and c)]] are effected sequentially.

50. The method according to claim 48 wherein the second direction and the third direction are perpendicular to the first direction.

51. A method of fabricating a unitary, honeycomb workpiece composed of piezoelectric material wherein the material is delivered continuously in a longitudinal direction from a nozzle in the manner of an extrusion process, and wherein the nozzle has a complementary counter-honeycomb structure corresponding to the honeycomb structure of the workpiece so as to obtain a plurality of passage openings running in a longitudinal direction in the workpiece.
